(19) United States
(12) Patent Application Publication
(10) Pub. No.: US 2024/0346524 A1
(43) Pub. Date: Oct. 17, 2024

(54) System and Methods for Optimizing Human Factors and Usability Engineering in Life Sciences Using Artificial Intelligence

(71) Applicant: Katia Mariel Rojas Garcia, New York, NY (US)

(72) Inventor: Katia Mariel Rojas Garcia, New York, NY (US)

(21) Appl. No.: 18/753,805

(22) Filed: Jun. 25, 2024

Related U.S. Application Data
(60) Provisional application No. 63/510,430, filed on Jun. 27, 2023.

(51) Int. Cl. G06Q 30/018; G06N 3/0475; G06N 3/088

(52) U.S. Cl. CPC G06Q 30/018; G06N 3/0475; G06N 3/088

(57) ABSTRACT

System and methods for enhancing human factors (HF) and usability engineering in the life sciences and healthcare industry integrating AI algorithms and techniques, ensuring adherence to key success factors, industry best practices, and regulatory demands. It includes software and hardware components, user interfaces, integration and communication functionalities, security mechanisms, and multimodality tools for documentation, analysis, reporting, AI-driven guidance and predictive analytics. Fit-for-purpose AI features enhance decision-making and automates complex tasks, including risk analysis, guided by practical HF principles while continuously learning and adapting. The cloud-based infrastructure enables secure access and sharing of project data, supported by a database storing device specifications, user demographics, and usage scenarios. The system supports AI-driven features, mixed reality, and IoT, providing a scalable, end-to-end solution for regulatory compliance and successful application of HF, addressing limitations of traditional HF methods, enhancing efficiency, accuracy, and effectiveness.

### CROSS-REFERENCE TO RELATED APPLICATIONS

This application claims the benefit of U.S. Provisional Application No. 63/510,430 filed on Jun. 27 of 2023 and titled: “AI System and Related Methods for Medical Device Human Factors & Usability Engineering Evaluation with Industry-Focused Framework”, which is incorporated herein by reference in its entirety for all purposes.

### FIELD OF THE INVENTION

The present invention relates to the field of human factors engineering, specifically to an AI-enhanced framework for successful application of human factors and usability engineering in the development of safe, effective, and user-friendly medical devices and other healthcare systems and products. The invention represents an intelligent, end-to-end adaptive system that optimizes the human factors process throughout the product development lifecycle, carefully aligning with regulatory standards and best practices.

### DESCRIPTION OF THE RELATED ART

Human factors engineering (HFE) focuses on optimizing the interactions between humans and products or systems they use, with the goal of improving safety, usability, and overall effectiveness. In the life sciences sector, where precision, accuracy, and user safety are paramount, effective application of HFE principles is essential. Ensuring medical devices are intuitive, drug packaging is accessible, and healthcare technologies facilitate efficient clinical workflows leads to successful adoption of these products.

As technology continues to advance and innovations drive the evolution of life sciences products, the integration of HFE principles in the development of medical devices and healthcare systems has become increasingly more critical in recent years. Regulatory bodies, such as the U.S. Food and Drug Administration (FDA), have recognized the importance of HFE in ensuring the safety, effectiveness, and usability of medical devices, as evidenced by the publication of the “Applying Human Factors and Usability Engineering to Medical Devices” guidance in 2016 [2].

However, the implementation of HFE in the medical device development industry has been accompanied by numerous challenges and shortcomings. Research conducted in this field has revealed significant issues that hinder the successful execution of HF validation projects and the achievement of regulatory compliance, hindering also innovation and patient safety [1] [4] [3].

Other initially identified challenges were a lack of comprehensive framework tailored to HF requirements, to foster alignment and standardization of best practices. For instance, conflicting feedback from regulatory bodies such as the FDA, coupled with the lack of clear guidelines on critical elements like user group identification, training protocols, study design, data utilization across regions, and aspects like Instructions for Use (IFU) validation and equivalency, significantly amplify the complexity of compliance and operational consistency. HFE encounters obstacles related to complexity, time efficiency, alignment, and regulatory compliance. [4]

Key stakeholders, including manufacturers and human factors service providers, often struggle to effectively integrate HFE into their processes. Challenges in aligning with regulatory expectations and seamlessly incorporating HFE activities into product development workflows can lead to suboptimal outcomes, such as delays, product redesigns, and medical devices that are not fully safe and effective, potentially causing patient harm and product recalls.

A staggering 96% of HFE submissions to the FDA are rejected due to deficiencies, indicating a pressing need for improvement in HFE practices. These deficiencies may include incomplete risk analysis, inadequate user groups, incorrect user training approach, and insufficient consideration of human factors during design and validation phases. [3], [4].

Traditionally, HFE solutions have focused on providing valuable insights into user interactions and product usability, critical aspects (such as objectivity, consistency/standardization, process maturity, and continuous improvement) have been neglected. There is a need for systematic solutions that provide stakeholders with the necessary tools to enhance quality, HFE process maturity levels, set benchmarks, ensure standardization and consistency, which will also enable alignment with quality management systems (QMS) regulations when it comes to HFE [5] [8].

Initial Solution: To address the discussed gaps so far, the Successful Human Factors 2.0 (SHF 2.0) framework was developed [6]. SHF 2.0 is comprehensive maturity model based on key success factors, structured methodologies, best practices, and regulatory alignment. The framework provides a foundation for successful application of HFE in MedTech product lifecycle, aiming to ensure alignment with QMS needs [8], standardization through its maturity component key categories of best practices, metrics, and a common language (See FIGS. 1 and FIGS. 2). Validation of the framework further proved the urgent need for standardization of identified best practices and key success factors [7].

Whereas the SHF 2.0 framework offers a valuable foundation for improving HFE practices and addressing critical gaps, it has limitations in fully addressing the dynamic and complex nature of the life sciences industry. Significant challenges persist, including stakeholder resistance, regulatory complexity, and limitations in scalability and adaptation to evolving industry trends and technologies. Moreover, traditional HFE approaches lack the sophistication required to meet the needs of rapidly evolving life sciences products and healthcare systems.

While the core standards initially integrated within the SHF 2.0 framework provide a robust base, the dynamic nature of medical device development often necessitates the incorporation of specific regulatory requirements for each targeted region. Additional and continuously updated standards and guidelines tailored to specific project needs and regional requirements may be a continuous pressure, such as for instance, the newer human factors guidance from the FDA which adds the human factors submission categorization [9].

The previous simply highlights the evolving nature of this field, and any potential solution must account for that). Additionally, collaboration mechanisms that ensure easy cooperation among stakeholders, including regulatory bodies, are still crucial for optimized and standardized HF reviews.

Furthermore, the manual nature of traditional HFE approaches often results in inefficiencies, scalability issues, and potential biases, which can hinder the effectiveness of the HFE process. Not to mention the extensive use of resource and need for efficiencies and more cost-effective solutions.

In summary, as a standalone solution, the SHF 2.0 framework does not provide the necessary scalability, adaptability, and dynamic data processing required to keep pace with the rapidly evolving regulatory landscape and the increasing complexity of medical devices and healthcare systems. As technology continues to advance and the complexity of healthcare products increases, traditional HFE approaches will continue to face significant challenges in keeping pace with evolving user needs, regulatory requirements, and industry best practices. There is a pressing need for a more advanced, technology-driven approach to human factors optimization.

### POTENTIAL OF AI FOR HUMAN FACTORS ENGINEERING

The rapid advancements in artificial intelligence (AI) technologies, including machine learning, neural networks, virtual reality (VR), augmented reality (AR), and the Internet of Things (IoT), have opened up transformative opportunities to revolutionize the field of human factors engineering (HFE) within the life sciences industry.

Keeping in mind that HFE is concerned with the interaction between humans and systems, it is important to remark that prior art has significantly explored incorporating HFE principles into AI systems development. Interestingly, the converse—leveraging AI to enhance and optimize HFE processes—had been unexplored up to the present disclosure.

HFE benefits tremendously from AI-enabled capability to address the previously discussed challenges as well as the many limitations of traditional HFE methods. Furthermore, to leverage the potential of the SHF 2.0 framework, it is imperative to implement innovative AI solutions that facilitate the seamless integration of HFE into life sciences complex systems.

Such AI-powered approaches can provide scalability, continuous adaptation (of particular importance in this constantly evolving industry), learning, and updating capabilities. By harnessing data sources that reflect regulatory trends and evolving best practices, this dynamic system can ensure that the principles of the SHF 2.0 framework remains robust, responsive, and aligned with current and future demands for successful HFE applications.

By integrating AI into the HFE process, we can unlock a range of transformative benefits, to analyze vast amounts of data, identify patterns, predict user behaviours (including risks), and optimize product design in ways that traditional methods cannot achieve. Usability Testing, where AI technologies offer real-time insights that accelerate product development cycles, eliminating the need for time-consuming manual procedures. Continuous Improvement: AI algorithms analyze user-device interactions, identifying design flaws and areas for improvement to enhance usability and safety. Analytics for Risk Mitigation: AI technologies predict usage patterns, identify potential risks, and guide design decisions to minimize hazards and prevent harm to users. Seamless Regulatory Compliance: The AI-powered system aligns workflows with regulatory expectations and integrates HFE best practices into product development from the earliest stages. harnessing the power of AI, organizations can revolutionize their human factors engineering practices, driving unprecedented efficiency, accuracy, and alignment with evolving industry demands and regulatory requirements.

### SUMMARY OF THE INVENTION

The following is a summary description of descriptive embodiments of the invention. It is provided as a preface to assist those skilled in the art to more rapidly assimilate the detailed design discussion, but it is not intended in any way to limit the scope of the claims which are appended hereto to particularly point out the invention. The present disclosure solves all the major limitations of challenges outlined so far, including of traditional human factors and usability engineering approaches.

Evolution of the Initial Solution—AI-Enhanced SHF 2.0: The incorporation of advanced AI technologies and techniques—including but not limited to a plurality of AI algorithms, multimodal data analysis, mixed realities and immersive user experiences, natural language processing (NLP). Machine Learning, neural networks and the Internet of Things (IoT)—significantly enhances the transformative potential and operationalization of the SHF 2.0 framework's underlying components.

The present invention (referred to as ‘AI-SHF system’ for the purpose of this disclosure) represents a groundbreaking advancement in HFE that seamlessly integrating cutting-edge artificial intelligence (AI) technologies with the principles of the Successful Human Factors (SHF) 2.0 framework. This synergistic combination elevates the framework's capabilities, transforming it into an intelligent, scalable and adaptive system that can significantly enhance the development of safe, effective, and user-friendly medical devices and healthcare products at every stage.

This innovative system is designed to drive collaboration, prioritize patient safety, and support successful innovation in the development of life sciences products and systems.

The AI-SHF System comprises a plurality of interconnected modules, each providing distinct and cohesive functionalities to address the diverse needs and requirements of human factors practitioners, product developers, and regulatory stakeholders.

In one embodiment, the AI-SHF System includes an AI-SHF Core module that integrates the core components of AI algorithms and techniques with the underlying SHF 2.0 framework. This module serves as the foundation for the system, bringing together innovative artificial intelligence capabilities and the proven best practices of the SHF 2.0 framework.

The system further comprises a Cloud Infrastructure module that provides a scalable, flexible, and secure cloud-based platform for hosting the AI-SHF System. This module includes features such as a computer-readable storage medium to store system instructions and adhere to human factors standards, as well as robust data security measures to protect sensitive information.

An AI & ML Capabilities module is also disclosed, which encompasses advanced machine learning algorithms and AI mechanisms. These capabilities enable domain-specific comprehensive data analysis, pattern recognition, correlation identification, and the generation of personalized recommendations. Furthermore, this module supports risk analysis and mitigation, optimization of project planning and execution, and data visualization to provide valuable insights.

The present invention also includes a User Interfaces module that delivers an intuitive and interactive experience for stakeholders. This module features knowledge exchange platforms, discourse mechanisms, project management functionalities, and the ability to input and retrieve project-specific data. Additionally, it comprises a chatbot/AI assistant, intelligent templates for human factors document generation, mixed reality simulations, and enhanced visualization tools.

Additionally, the AI-SHF System includes a Stakeholder Collaboration module that facilitates effective collaboration among the diverse stakeholders involved in human factors projects. This module offers communication channels, knowledge sharing features, a resource library, and coordination mechanisms to enable seamless interactions between human factors practitioners, designers, researchers, and regulatory experts.

The invention further discloses a Regulatory Compliance module that ensures the AI-SHF System adheres to relevant regulatory guidelines and industry standards. This module includes ongoing compliance mechanisms, adherence to human factors practices and standards, and alignment with FDA and other regulatory requirements to support successful submissions and approvals.

The AI-SHF System also comprises a Risk Management module that focuses on identifying, analyzing, and mitigating use-related risks. This module includes functionalities for tracing use-related risks, performing comprehensive risk analysis and hazard analysis, and developing effective risk mitigation strategies. It also centralizes insights on use errors to inform continuous improvement.

The present application further provides a Training and Education module that offers educational materials and training resources to enhance stakeholders' understanding and capabilities in human factors engineering. This module supports the development of expertise and the adoption of best practices, contributing to the overall success of human factors projects.

Additionally, the AI-SHF System includes a Data Management module that handles the collection, organization, and utilization of various data sources relevant to human factors projects. This module encompasses project-specific data, device attributes, IoT and system data, user demographics, and functionalities for procurement and acquisition of necessary data.

The disclosed invention comprises a Continuous Improvement module that enables the AI-SHF System to evolve and enhance its recommendations over time. This module integrates user evaluations, adjusts project-specific data, and continuously refines the system's algorithms and outputs through an iterative refinement and self-learning process.

The AI-enhanced framework incorporates predictive analytics, enabling the system to analyze data from previous human factors studies, user feedback, and market trends. This allows AI-SHF to identify user preferences, forecast the success of medical devices and healthcare products, and proactively address potential challenges early in the design process.

AI-SHF also automates the HF process by utilizing GenAI technologies to generating and automate tasks, summary, reports, including usability testing results, risk assessments, and user interface design recommendations. This feature ensures consistency, compliance with regulatory standards, and adaptability to meet the specific requirements of different markets and regulatory bodies.

The invention is designed to foster collaboration among human factors professionals, designers, engineers, and other stakeholders through a centralized platform for communication, data sharing, and project management. This collaborative ecosystem accelerates innovation and facilitates the development of user-centered solutions.

Furthermore, the invention is designed to be globally scalable, accommodating the diverse needs and requirements of medical device and healthcare product development across different regions and markets. The AI-powered system adapts to local regulations, cultural preferences, and user characteristics, ensuring that the developed products are suitable for their intended audiences worldwide.

Embodiments of the present invention features a cloud-based infrastructure that allows stakeholders secure access to and sharing of project-specific data, tools, and resources. A plurality of user interfaces enables stakeholders to interact with the system. A real-time insights and predictive analytics module aids informed decision-making and anticipates potential issues through data analysis.

Additionally, the system includes a collaboration module to facilitate communication and coordination among stakeholders, and a data security mechanism to ensure the confidentiality and integrity of data. A computer-readable storage medium stores instructions, algorithms, and data. The communication network links user interfaces to other system components, providing internet connectivity.

The AI-SHF system employs various AI and machine learning algorithms and techniques to analyze large datasets and generate personalized recommendations based on project data and industry knowledge. It interprets regulatory guidance documents to offer consistent recommendations for compliance. User-friendly interfaces facilitate data input and collaboration, and input functionalities include tools for entering project-specific data.

The data security mechanism incorporates encryption, access controls, and secure storage protocols to safeguard information. A real-time feedback and iteration module captures feedback and integrates iterative improvements. It employs natural language processing (NLP) for analyzing user feedback. The AI-driven recommendation module, coupled with self-learning capabilities, refines recommendations over time.

The system also provides performance monitoring and analytics capabilities to track project effectiveness and identify improvement areas. It uses virtual simulations to replicate real-world scenarios, identifies usability issues, and validates interventions before physical prototypes.

Intelligent decision support tools assist human factors practitioners and project managers in making informed decisions. The system automates the generation of documentation and reports using a plurality of AI algorithm and techniques.

The cloud-based infrastructure includes a database for storing device specifications, user demographics, and use scenarios, alongside a machine learning engine for analyzing regulatory documents. Security mechanisms ensure data protection and regulatory compliance. Additionally, the system incorporates ethical AI practice protocols to ensure transparency and fairness.

A computer-implemented method includes receiving project data, using AI algorithms to analyze data and generate recommendations, incorporating SHF 2.0 principles into validation processes, and providing real-time feedback. It supports regulatory compliance by offering guidance, templates, and documentation, and uses multimodal analysis, such as textual, visual, auditory, and contextual data, to enhance design and usability.

The method also includes monitoring project performance, identifying improvement areas, analyzing project data to extract insights, in conjunction with applicable regulatory standards, and conducting virtual simulations for testing. IoT connectivity allows real-time data collection, and NLP may be used in combination with other AI technologies to analyze user feedback. Intelligent decision support tools based on project data and best practices are provided, and the system continuously learns from emerging trends and regulatory updates.

Collaboration among stakeholders is facilitated, allowing for knowledge sharing and best practice exchange. The system supports managing human factors projects, including task management, milestone tracking, and resource allocation. It also identifies, assesses, and mitigates use-related risks and integrates seamlessly with existing industry systems, such as quality management systems (QMS) and design control systems.

The AI-Powered Successful Human Factors (AI-SHF) System, as described herein, provides a comprehensive and innovative solution for human factors engineering, leveraging the power of artificial intelligence to drive collaboration, prioritize patient safety, and support successful innovation in the life sciences industry.

### OBJECTIVES

One primary objective of the invention is to provide human factors professionals with real-time, context-aware guidance, ensuring adherence to best practices and regulatory requirements. By leveraging the vast knowledge base of the SHF 2.0 framework and the power of AI. The invention offers personalized recommendations and insights to streamline the development process and mitigate potential usability issues.

Another principal object of the present invention is to revolutionize the field of medical device development by synergistically integrating artificial intelligence (AI) technologies with regulatory compliance frameworks and user-centered design principles, thereby creating an unprecedented ecosystem that optimizes product usability, safety, and adherence to regulatory standards on a global scale.

A further object of the invention is to markedly enhance the success rates of human factors validation efforts by furnishing stakeholders with a pioneering suite of AI-powered tools, resources, and recommendations that seamlessly align with the integrated ecosystem.

Another important object is to substantially minimize deficiencies in HFE submissions and thereby increase the likelihood of regulatory approval for medical devices across a multitude of regions and jurisdictions, leveraging the AI-driven compliance framework.

Yet another object is to innovatively create a collaborative environment that seamlessly enables interaction, experience sharing, and dissemination of knowledge among human factors practitioners, medical device manufacturers, regulatory experts, and other key stakeholders within the integrated ecosystem.

An additional object is to effectively facilitate standardization of HFE practices across the industry through systematic dissemination of knowledge, ensuring consistent adherence to prevailing best practices and the AI-driven compliance framework.

A further important object is to astutely ensure robust and active engagement of all stakeholders, thereby cultivating a collaborative approach distinctly capable of addressing ongoing challenges and rapidly evolving requirements in the HFE domain, in alignment with the integrated ecosystem.

Another significant object is to maintain stakeholders continuously informed about new developments, research findings, regulatory changes, and industry trends, thereby ensuring comprehensive alignment and consistent objectives across the entire AI-driven ecosystem.

A further innovative object is to markedly streamline project management for HFE projects by providing pioneering tailored tools, methodologies, and functionalities that harness the power of AI, ensuring optimized planning, execution, reporting, and regulatory adherence within the integrated ecosystem.

Yet another important object is to substantially increase the quality of HFE projects while concurrently reducing rejection rates by regulatory agencies across diverse regions through intelligent implementation of industry best practices, stringent compliance with regulatory standards, and leveraging the AI-driven compliance framework.

A further valuable object is to ingeniously enable customized regulatory compliance adaptation in HFE validation practices by automatically determining region-specific regulatory requirements and generating personalized compliance reports tailored to individual regulatory standards, thereby facilitating streamlined global compliance within the integrated ecosystem.

Another key object is to promote a user-centric design approach in medical device development through comprehensive understanding and meticulous addressing of user needs, preferences, and potential use errors, thereby improving user experience and safety, as facilitated by the AI-driven ecosystem.

A further significant object is to expedite the development of medical devices that distinctly prioritize user safety, usability, and overall user experience, thereby enhancing patient outcomes and satisfaction to an unprecedented degree, as enabled by the synergistic integration of AI, regulatory compliance, and user-centered design principles.

Yet another important object is to proactively encourage innovation and regulatory compliance in the HFE field by providing stakeholders with fit-for-purpose AI solutions, models, cutting-edge tools, methodologies, and resources hitherto unavailable, enabling them to remain at the forefront of industry advancements while assiduously meeting evolving regulatory requirements within the integrated AI-driven ecosystem.

Yet another object of the present invention is to facilitate the embedding and tight integration of human factors considerations throughout the product development lifecycle, and as part of stakeholders QMS, enabling a cohesive approach where usability, safety, and regulatory compliance aspects are intrinsically unified and interwoven into the design and development processes from initial conception.

Another object is to facilitate the expeditious development of strikingly innovative yet meticulously compliant medical devices that meet the highest standards of safety and effectiveness, thereby driving transformative progress in the healthcare industry while simultaneously ensuring utmost patient well-being, as achieved through the groundbreaking integration of AI technologies, regulatory compliance frameworks, and user-centered design principles.

Other objectives and features of the present invention will become evident from the following detailed description, which should be viewed in conjunction with the accompanying drawings. It is to be noted, however, that the drawings are provided for illustrative purposes only and should not be construed as defining the boundaries of the invention. For a more precise delineation of the invention's scope, refer to the claims of this disclosure.

### BRIEF DESCRIPTION OF THE DRAWINGS

FIG. 1 and FIG. 2: Illustrate the foundational components of the initial standalone solution SHF 2.0 Framework, detailing the Project Management (PM) dimension and Human Factor Engineering (HFE) dimension.

FIG. 3: Depicts the AI-Enhanced SHF 2.0 Framework (AI-SHF), including its core AI Engine and key components like intelligent guidance, predictive analytics, automated documentation/reporting, and collaborative ecosystem features.

FIG. 4: Shows the structured iterative cycle of the human factors process within AI-SHF, including phases such as design optimization, use-related risk analysis, formative studies, validation protocol, and study execution.

FIG. 5: Outlines a user-centered design approach within the AI-SHF framework, highlighting steps from user research through design optimization.

FIG. 6 and FIG. 7: Provide standard phases in healthcare and MedTech product development lifecycle, showcasing AI-SHF integration across stages from concept to post-market.

FIG. 8: Presents a flowchart for a computer-implemented method of conducting human factors projects for medical devices and combination products using the AI-SHF system.

FIG. 9: Offers a schematic representation of AI-SHF system components, delineating modules covering AI algorithms, stakeholder collaboration, regulatory compliance, and continuous improvement.

FIG. 10: Illustrates the operational flow of AI-SHF system's contribution to human factors & usability engineering in life sciences product development.

FIG. 11: Shows a visually organized representation of the AI-SHF ecosystem, emphasizing the connectivity between stakeholders, regulatory bodies, data management, and project management within the framework.

FIG. 12 and FIG. 13: Exhibit implementation components of AI-SHF system, including data collection tools, usability testing tools, AI engine algorithms & data models, virtual simulation environment, and natural language processing capabilities.

FIG. 14: Describes the multimodal functionalities of the AI-SHF Core, incorporating various AI technologies for enhanced HFE processes.

FIG. 15: Outlines the structure of the human factors and usability database within the AI-SHF system, including user behavior, use risks, usability testing data, and historical data.

FIG. 16: Illustrates the flow of the Automated Reporting Module within the AI-SHF system, from data collection to final report delivery.

FIG. 17: Details a system diagram for implementing the SHF 2.0 framework with AI technologies, showcasing user device interaction, cloud communication, and IoT connectivity.

FIG. 18: Provides a block diagram of the AI-SHF system, showcasing integrated modules such as the AI-SHF Core, cloud-based infrastructure, user interfaces, and real-time insights and predictive analytics capabilities.

### DETAILED DESCRIPTION OF THE INVENTION

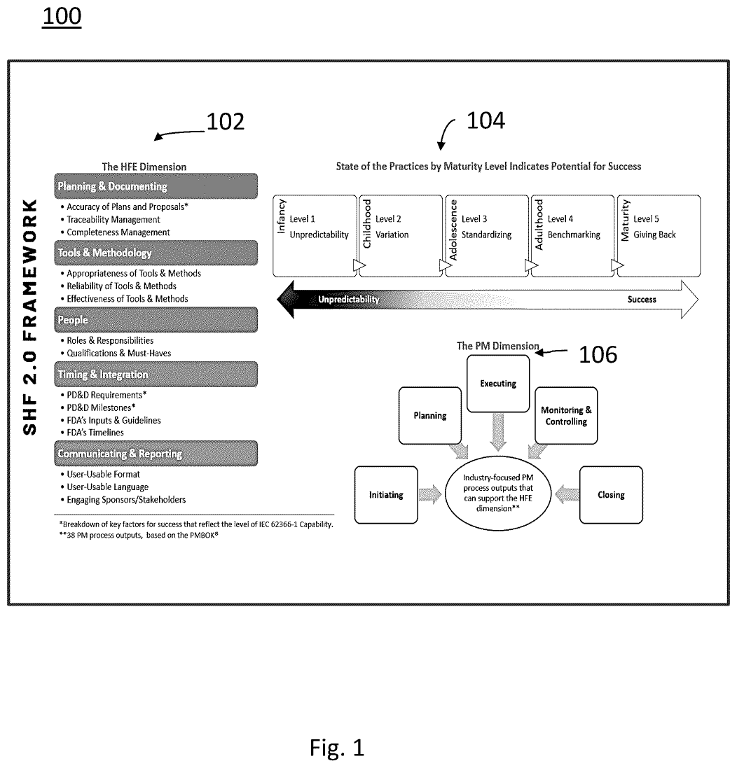

The principles of the present invention and their advantages are best recognized by referring to FIGS. 1 to 18. In the following detailed description, numerous specific details are set forth to provide a thorough understanding of the embodiment of the invention as illustrative or exemplary embodiments of the invention, specific embodiments in which the invention may be practiced are described in sufficient detail to enable those skilled in the art to practice the disclosed embodiments. However, it will be obvious to a person skilled in the art that the embodiments of the invention may be practiced with or without these specific details. In other instances, well-known methods, procedures and components have not been described in detail so as not to unnecessarily obscure aspects of the embodiments of the invention.

The following detailed description is, therefore, not to be taken in a limiting sense, and the scope of the present invention is defined by the appended claims and equivalents thereof. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. References within the specification to “one embodiment,” “an embodiment,” “embodiments,” or “one or more embodiments” are intended to indicate that a particular feature, structure, or characteristic described in connection with the embodiment is included in at least one embodiment of the present invention.

Although the terms first, second, etc. may be used herein to describe various elements, these elements should not be limited by these terms. These terms are generally only used to distinguish one element from another and do not denote any order, ranking, quantity, or importance, but rather are used to distinguish one element from another. Further, the terms “a” and “an” herein do not denote a limitation of quantity, but rather denote the presence of at least one of the referenced items.

The conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. The following brief definition of terms shall apply throughout the present invention:

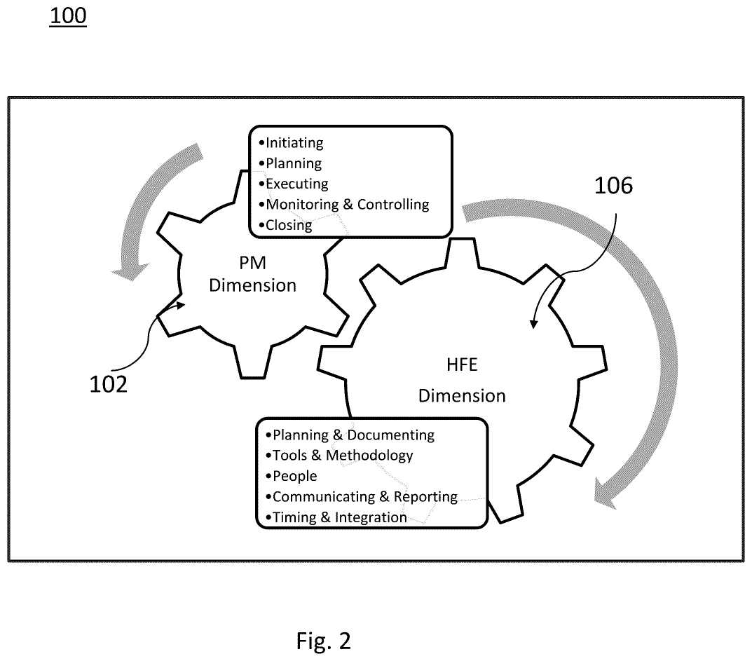

Referring to FIGS. 1 to 18, now FIG. 1 and FIG. 2 illustrate the underlying components of the initial SHF 2.0 Framework 100 in accordance with one embodiment of the present invention comprises PM (Project management) dimension 102 and HFE (Human factor engineering) dimension 106. In the embodiment, the SHF 2.0 Framework comprises HFE dimension 106, state of practices by maturity level 104, and PM dimension 102. The HFE dimension 106 illustrates the different stages and professionals involved in the development and validation of medical devices. The HFE dimension 106 comprises Planning and Documenting, tools and methodology, people's role and responsibility with qualification criteria, timing and integration, communication and reporting. The HFE dimension 106 may comprise state of practices 104 by maturity level involving potential of success i.e. unpredictability or success. The potential of success increases with the increase of maturity and unpredictability is highest when maturity level is infancy. PM dimension 102 that supports HFE dimension 102 comprises initiation, planning, execution, monitoring and controlling and closing.

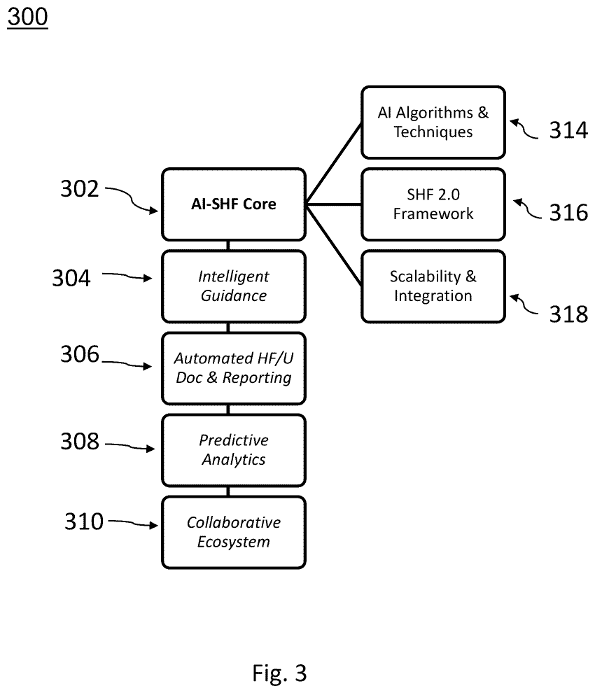

FIG. 3 illustrates in high-level the AI-Enhanced SHF 2.0 Framework, referred to as AI-SHF, which integrates artificial intelligence capabilities to optimize human factors processes in medical device and healthcare product development by operationalizing the principals of the initial framework using a plurality of AI technologies. At the Core is the SHF AI Engine. This would be the central software component that houses the algorithms, machine learning models, natural language processing (NLP) capabilities, computer vision models, predictive analytics engines, etc. It would act as the backbone of the entire system, providing the necessary intelligence and processing power. In a nutshell, 302 provides intelligent guidance, automation, and predictive analytics for human factors activities and comprises the following key components: Intelligent Guidance 304 component leverages AI and machine learning algorithms to provide intelligent and context-aware guidance to users throughout the human factors process. It offers recommendations, best practices, and actionable insights based on the SHF 2.0 framework and relevant standards and regulations. Predictive analytics 306 component utilizes AI and data modelling techniques to analyze historical data, user interactions, and project-specific information. It identifies patterns, trends, and potential risks, enabling proactive decision-making, risk mitigation strategies and success prediction. Automated HF and Usability Testing Documentation and Reporting 308 component automates the production of HF and Usability Testing tasks, deliverables, documentation and reporting process within human factors projects, reducing manual efforts and increasing efficiency. It generates accurate and standardized documentation based on project requirements, user inputs, and principles of the SHF 2.0 framework. The Collaborative Ecosystem 310 facilitates seamless collaboration and knowledge-sharing among team members working on human factors projects. It enables real-time communication, task assignment, and centralized access to project information and resources. Global Scalability and Integration 312 allows organizations to integrate and implement AI-SHF across diverse projects, regions, and markets worldwide. 312 ensures customized and consistent application of human factors best practices and compliance with relevant regulations as needed, as well integration and interoperability. This is high-level representation of cutting-edge AI technologies to streamline and optimize human factors processes, ultimately contributing to the development of safe, user-friendly, and effective medical devices and healthcare products that meet regulatory requirements and user needs.

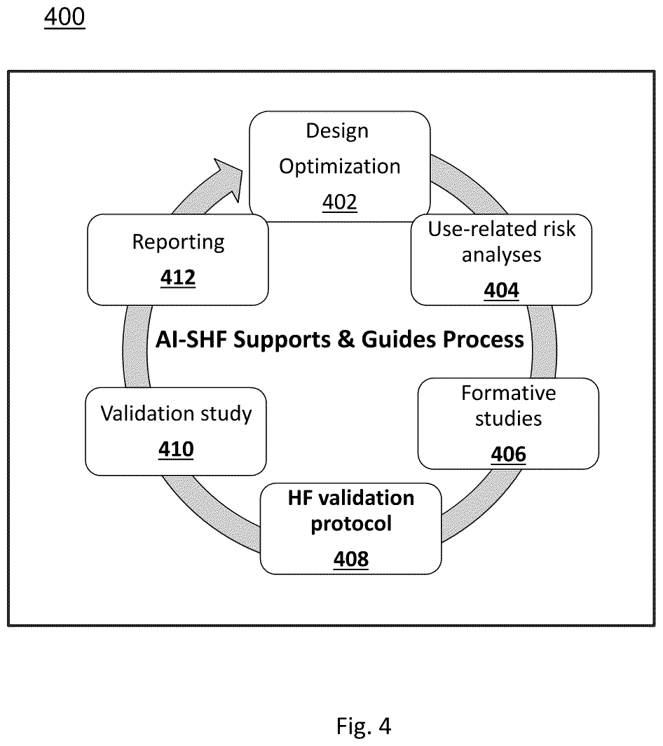

FIG. 4 exemplifies the systematic iterative cycle 400 diagram of a structured human factors process within in accordance with one embodiment of the AI-SHF, focusing on the optimization of usability and safety, 402 Design Optimization is the initial phase emphasizing the iterative process of refining the design to enhance usability and user experience. Design elements are optimized based on user feedback and usability studies to ensure a user-centered approach. 404 Use-Related Risk Analyses is the next step which involves conducting thorough use-related risk analyses to identify and mitigate potential risks associated with product use. Risk assessments are vital to enhancing safety and ensuring user interactions are free from harm. 406—Formative Studies: Formative studies are conducted to iteratively test and refine the design concepts based on user feedback. Through these studies, usability issues are uncovered and addressed to improve the overall design effectiveness. 408—HF Validation Protocol: The development of the HF Validation Protocol is crucial to establishing standardized testing procedures and methodologies for the validation study. This protocol ensures that all necessary steps are defined and followed during the validation process. 410—Validation Study: The validation study phase involves comprehensive usability testing to confirm that the design meets usability standards and user requirements. Real-world scenarios are simulated to assess user interactions and validate the usability of the product. 412—Reporting: Upon completion of the validation study, a detailed report is generated to document the findings, outcomes, and recommendations. The report summarizes the validation process, highlighting key insights for design improvements and regulatory compliance.

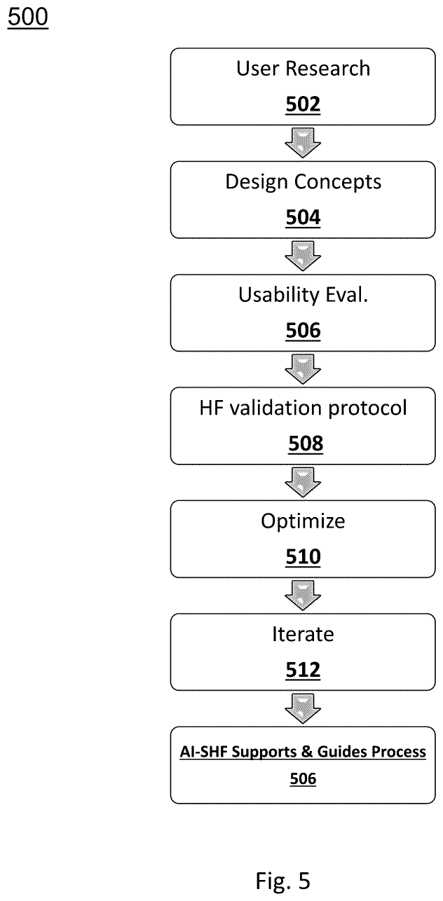

FIG. 5 illustrates a user-centered design approach 500 in accordance with one embodiment of the present invention, highlighting the iterative process of research, design, and evaluation employed during product lifecycle. The user-centered design approach 500 comprises the following steps: 502—User Research: This initial step involves the systematic study of user behaviors, needs, and preferences to gather insights critical for designing user-centered products. Methods such as interviews, surveys, observations, and usability studies are employed to understand user requirements. 504—Design Concepts: Based on the user research findings from step 502, potential design solutions are developed in this step. This includes brainstorming, ideation, and creating different design alternatives that address identified user needs and enhance usability. 506—Usability Evaluation: In this step, the design concepts from step 504 are tested and assessed with real users through usability testing. Users interact with prototypes, allowing the identification of usability issues, gathering of feedback, and validation of the effectiveness of the design solutions. 508—Optimize: The feedback and insights gained from the usability evaluation in step 506 are used to optimize and refine the design in this step. The focus is on incorporating user feedback and enhancing the usability of the product to ensure it meets user needs effectively. 510—Iterate: This step represents the iterative loop, emphasizing the cyclical nature of the user-centered design approach within the AI-SHF. The design process involves continuous feedback, testing, and refinement throughout the product development lifecycle. 512—AI-SHF. Support & Guide Process: AI-SHF supports and guides the user-centered design approach 500 throughout the iterative process, providing intelligent recommendations, data analysis, and automation to facilitate effective product development.

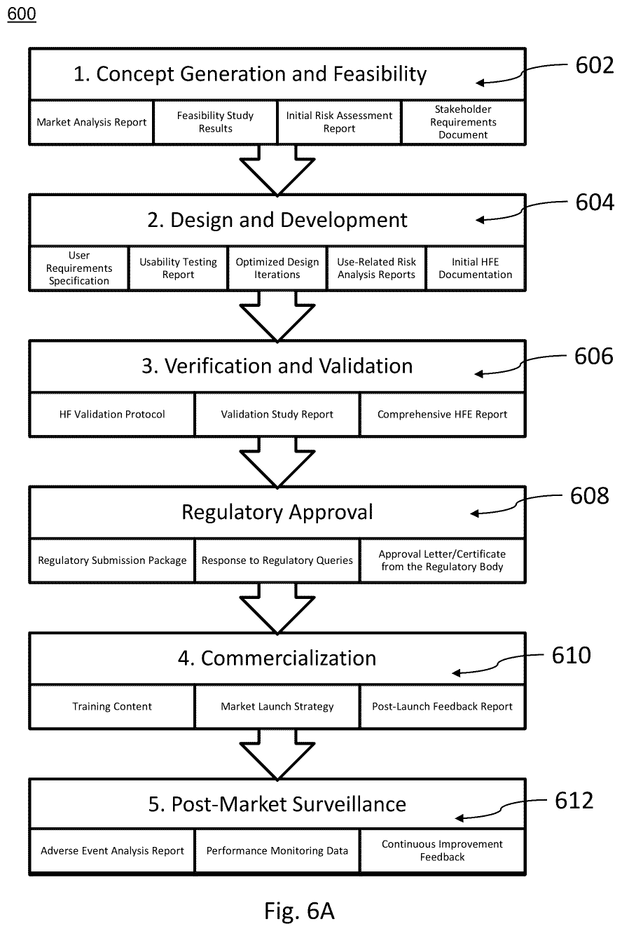

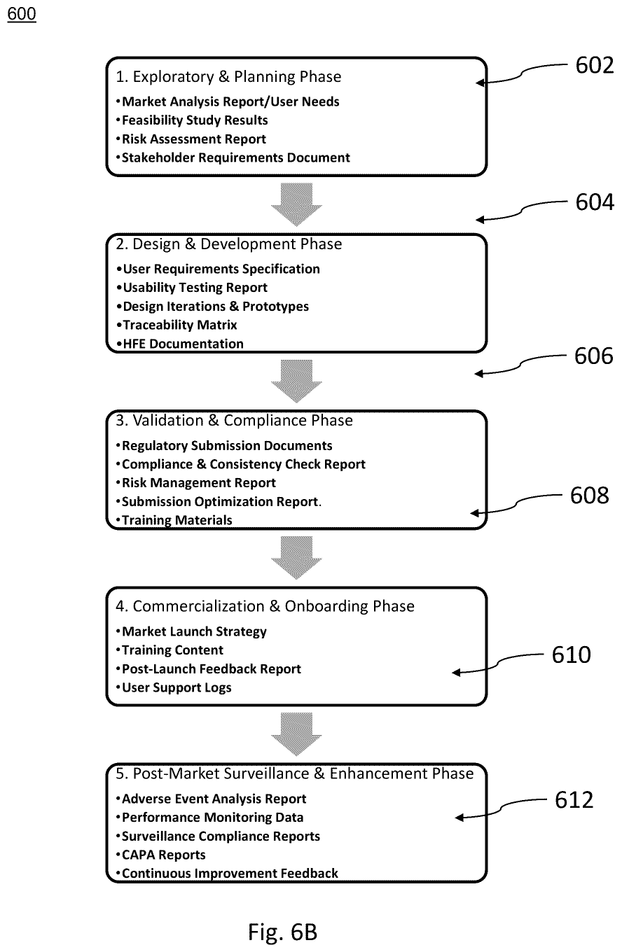

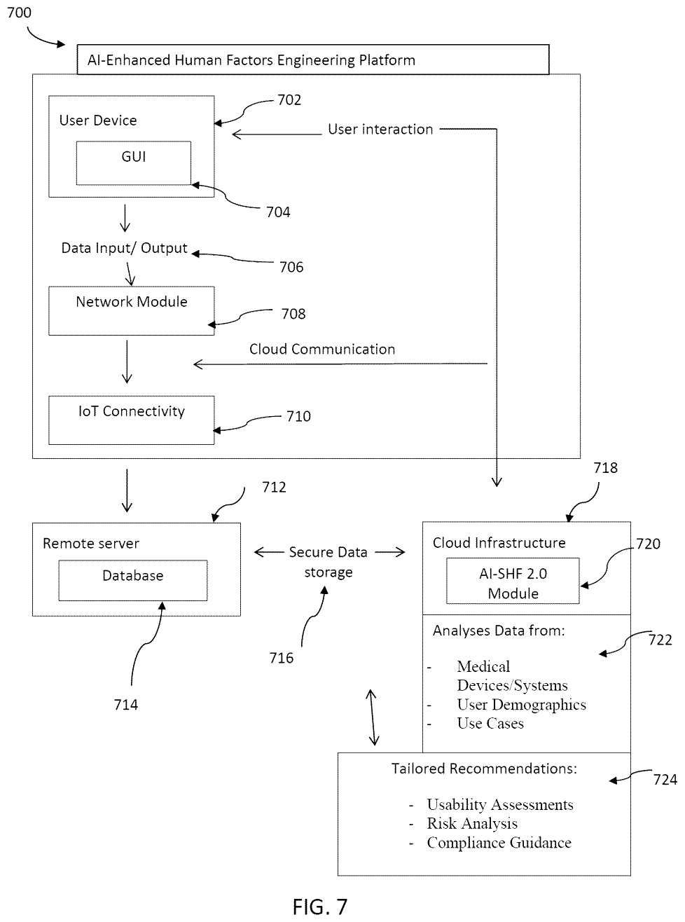

FIG. 6 and FIG. 7 illustrate standard stages or phases in healthcare and MedTech product development lifecycle process 600 in accordance with one embodiment of the present invention to offer a clear visualization of how AI-SHF contributes to the overall development process of the technology, emphasizing its impact on usability, safety, and efficiency.

The diagram is designed to provide a high-level overview of the integration of the AI-SHF at every phase of product lifecycle, allowing viewers to understand where and how the framework interacts with the development stages, although organizations may take slightly different approaches, these typically involve essential activities that go from early exploratory research, design, development, regulatory, commercialization to post-market surveillance. The AI-SHF is integrated throughout the product development lifecycle process 600, to embed HFE from early concepts to post-market, providing intelligent guidance, automation, and predictive analytics capabilities to optimize usability, safety, and efficiency at every stage. In that sense, the product development lifecycle process 600 may comprise the following stages or phases:

Concept Generation and Feasibility 602: This initial stage involves the generation of product concepts and the evaluation of their feasibility. It includes the following key activities and deliverables: Market Analysis Report: Conducting market research to understand user needs, market trends, and competitive landscape. Feasibility Study Results: Assessing the technical and commercial viability of the product concept. Initial Risk Assessment Report: Identifying and evaluating potential risks associated with the product concept. Stakeholder Requirements Document: Capturing and documenting the requirements and expectations of various stakeholders.

Design and Development 604 is the stage where the product design is developed, and iterative usability testing is conducted. It includes the following key activities and deliverables: User Requirements Specification: Defining the detailed user requirements based on stakeholder inputs and market analysis. Usability Testing Report: Conducting usability testing with representative users to evaluate the design and identify usability issues. Optimized Design Iterations: Iterating and refining the product design based on usability testing feedback. Use-Related Risk Analysis Reports: Analyzing and documenting the potential use-related risks associated with the product design. Initial HFE Documentation: Preparing initial human factors engineering (HFE) documentation, including design rationale and risk mitigation strategies.

Verification and Validation 606 stage involves the verification and validation of the product design, including comprehensive human factors validation studies. It includes the following key activities and deliverables: HF Validation Protocol: Developing a detailed protocol for conducting human factors validation studies. Validation Study Report: Executing human factors validation studies and documenting the results and findings. Comprehensive HFE Report: Preparing a comprehensive report summarizing the human factors engineering activities and outcomes.

Regulatory Approval (608): In this stage, the necessary regulatory submissions are prepared, and approval from the relevant regulatory bodies is obtained. It includes the following key activities and deliverables: Regulatory Submission Package: Compiling and submitting the required documentation for regulatory approval. Response to Regulatory Queries: Addressing and responding to queries or requests for additional information from the regulatory authorities. Approval Letter/Certificate from the Regulatory Body: Obtaining the final approval or clearance for the product from the regulatory body.

Commercialization (610): This stage focuses on the commercialization and market launch of the approved product. It includes the following key activities and deliverables: Training Content: Developing training materials and resources for end-users and healthcare professionals. Market Launch Strategy: Formulating and executing a strategy for the successful market launch of the product. Post-Launch Feedback Report: Gathering and analyzing feedback from end-users and stakeholders after the product launch.

Post-Market Surveillance (612): This stage involves ongoing monitoring and surveillance of the product's performance and safety in the post-market environment. It includes the following key activities and deliverables: Adverse Event Analysis Report: Analyzing and reporting any adverse events or safety issues related to the product. Performance Monitoring Data: Collecting and analyzing data on the product's performance in real-world use. Continuous Improvement Feedback: Identifying opportunities for product improvements based on post-market data and feedback.

In reference to FIG. 7, one embodiment of the AI-Enhanced Human Factors Engineering. System 700 is disclosed that illustrates a plurality of high-level components and data flows of the AI-Enhanced Human Factors Engineering system. A device 702 with a GUI 704 for interaction, cloud communication via network modules 708 and IoT connectivity 710, and the remote server 712 with database 714 and cloud infrastructure 718 hosting the AI-SHF 2.0 module 720 responsible for data analysis 722 and generating tailored recommendations 724. In the embodiment, the data analysis 722 is based on medical devices/systems, user demographics and user cases. The tailored recommendation 724 is for usability assessment, risk analysis and compliance recommendation. The cloud infrastructure 718 provides secure data storage 716 at remote server 712.

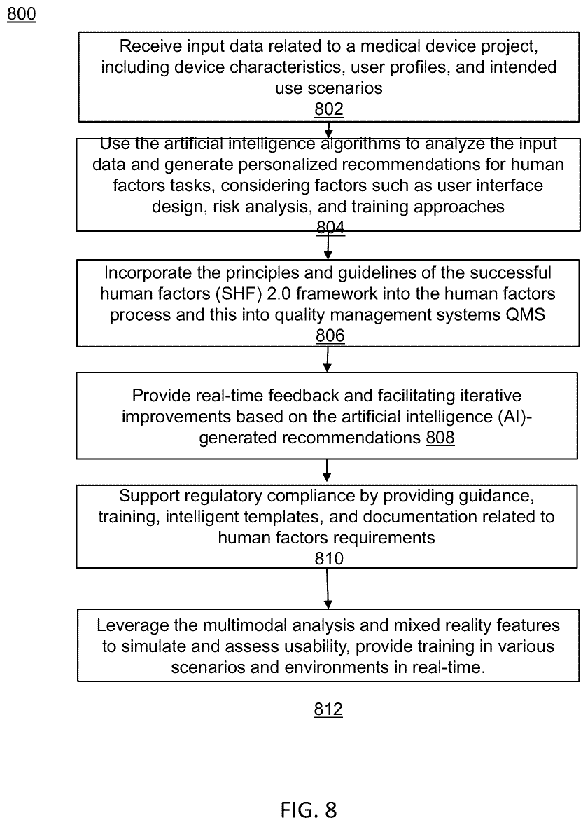

FIG. 8 illustrates a flowchart representing one example of a computer-implemented method 800 for conducting certain aspects of human factors projects for medical devices and combination products, in accordance with an embodiment of the present invention. The method 800 comprises the following steps. At 802, receiving input data related to a medical device project, including device characteristics, user profiles, and intended use scenarios. At 804, using artificial intelligence algorithms to analyze the input data and generate personalized recommendations for human factors projects, considering factors such as user interface design, risk analysis, and training approaches; At 806, incorporating the principles and guidelines of the successful human factors (SHF) 2.0 framework into the human factor's validation process. At 808, providing real-time feedback and facilitating iterative improvements based on the artificial intelligence (AI)-generated recommendations. At 810, supporting regulatory compliance by providing guidance, templates, and documentation related to human factors projects submissions. At 812, leveraging the multimodal analysis to simulate and assess usability in various scenarios and environments in real-time. The multimodal analysis may include textual, visual, auditory, and contextual data analysis.

The method 800 further includes monitoring the performance of human factors projects strategies, identifying areas for improvement, and measuring their impact on product success and user satisfaction. The method 800 further includes adapting to accommodate a wide range of medical device projects and evolving industry standards and regulations. The method 800 further includes analyzing data collected during human factors projects to identify patterns, detect anomalies, and extract insights. Further, method 800 further includes conducting virtual simulations to replicate real-world scenarios, identify usability issues, evaluate design alternatives, and validate the effectiveness of human factors interventions. The method 800 further includes utilizing internet of things (IoT) connectivity for real-time data collection from interconnected medical devices, contributing to a centralized database of user behavior data and use-context information.

The method 800 further includes analyzing user feedback using natural language processing (NLP) to understand user sentiments and identify recurring issues. The method 800 further includes providing intelligent decision support tools for human factors practitioners and project managers, based on project data, regulatory requirements, and industry best practices. The method 800 further includes automating the generation of documentation and reporting for human factors projects. The method 800 further includes continuously learning from new data, emerging trends, and regulatory updates to improve decision-making capabilities over time.

The method 800 further includes facilitating collaboration among stakeholders, allowing them to share best practices, exchange knowledge, and learn from each other's experiences. The method 800 further includes managing human factors projects, including task management, milestone tracking, resource allocation, and collaboration features. The method 800 further includes supporting the identification, assessment, and mitigation of use-related risks associated with medical devices. The method 800 further includes seamlessly integrating with existing systems and tools used in the medical device industry, such as quality management systems (QMS) and design control systems, to account for HFE processes.

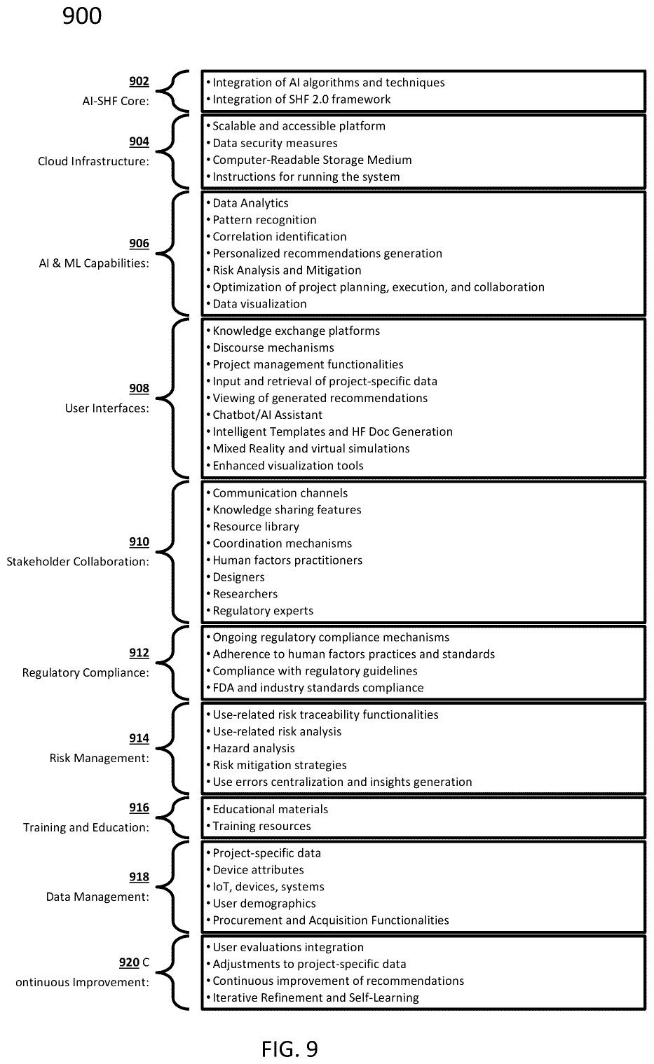

FIG. 9 is a schematic representation of the components of the AI-SHF system described as modules within this overarching system, in accordance with one embodiment of the disclosed invention. The modules collectively cover the essential aspects of an advanced, AI-integrated human factors engineering system, including the core framework, infrastructure, AI/ML capabilities, user experience, stakeholder collaboration, regulatory compliance, risk management, training, data management, and continuous improvement, as explained in more details next.

902 discloses an AI-SHF Core module that integrates advanced AI algorithms and techniques with the underlying SHF 2.0 framework. This core module serves as the foundation for the AI-powered SHF system, bringing together innovative artificial intelligence capabilities and the proven best practices of the Successful Human Factors (SHF) 2.0 framework to drive collaboration, prioritize patient safety, and support successful innovation.

904 Cloud Infrastructure—The instant application further provides a Cloud Infrastructure module that offers a scalable, flexible, and secure cloud-based platform for hosting the AI-SHF system. This module includes features such as a computer-readable storage medium to store system instructions and adhere to human factors standards, as well as robust data security measures to protect sensitive information, thereby enhancing the system's reliability and data protection.

906 AI & ML Capabilities—Additionally, the present invention discloses an AI & ML Capabilities module that encompasses advanced machine learning algorithms and AI mechanisms. These capabilities enable comprehensive data analysis, pattern recognition, correlation identification, and the generation of personalized recommendations. Furthermore, this module supports risk analysis and mitigation, optimization of project planning and execution, and data visualization to provide valuable insights.

908 User Interfaces—The disclosed invention also includes a User Interfaces module that delivers an intuitive and interactive experience for stakeholders. This module features knowledge exchange platforms, discourse mechanisms, project management functionalities, and the ability to input and retrieve project-specific data. Additionally, it comprises a conversational AI such as chatbot assistant, intelligent templates for human factors document generation, mixed reality simulations, and enhanced visualization tools.

910 Stakeholder Collaboration—The present application further provides a Stakeholder Collaboration module that facilitates effective collaboration among the diverse stakeholders involved in human factors projects. This module offers communication channels, knowledge sharing features, a resource library, and coordination mechanisms to enable seamless interactions between human factors practitioners, designers, researchers, and regulatory experts.

912 Regulatory Compliance—The instant invention also discloses a Regulatory Compliance module that ensures the AI-SHF system adheres to relevant regulatory guidelines and industry standards. This module includes ongoing compliance mechanisms, adherence to human factors practices and standards, and alignment with FDA and other regulatory requirements to support successful submissions and approvals.

914 Risk Management—Furthermore, the present disclosure describes a Risk Management module that focuses on identifying, analyzing, and mitigating use-related risks. This module includes functionalities for tracing use-related risks, performing comprehensive risk analysis and hazard analysis, and developing effective risk mitigation strategies. It also centralizes insights on use errors to inform continuous improvement.

916 Training and Education—The instant application further provides a Training and Education module that offers educational materials and training resources to enhance stakeholders' understanding and capabilities in human factors engineering. This module supports the development of expertise and the adoption of best practices, contributing to the overall success of human factors projects.

918 Data Management—The present invention also includes a Data Management module that handles the collection, organization, and utilization of various data sources relevant to human factors projects. This module encompasses project-specific data, device attributes, IoT and system data, user demographics, and functionalities for procurement and acquisition of necessary data.

920 Continuous Improvement—Finally, the disclosed invention comprises a Continuous Improvement module that enables the AI-SHF system to evolve and enhance its recommendations over time. This module integrates user evaluations, adjusts project-specific data, and continuously refines the system's algorithms and outputs through an iterative refinement and self-learning process.

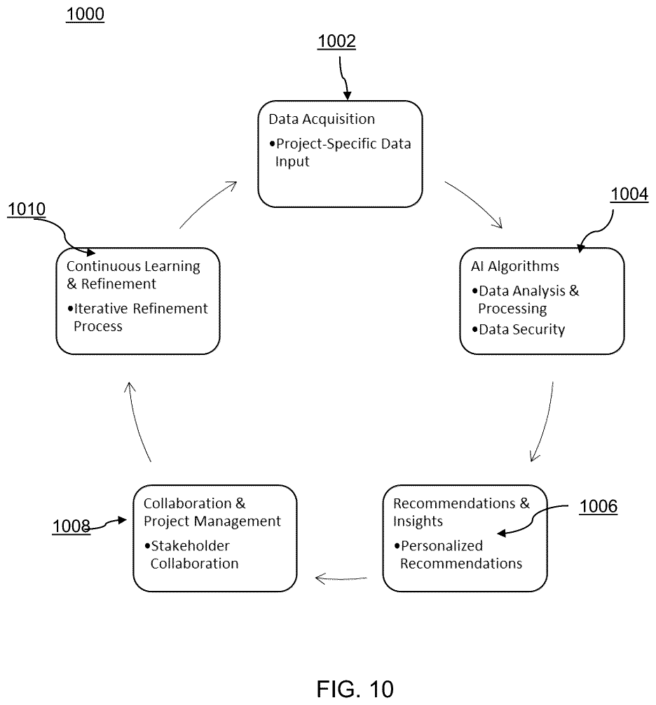

FIG. 10 illustrates an exemplary operational flow of a computer-implemented AI-SHF system 1000 intelligent integration of human factors & usability engineering to life sciences products and systems development, in accordance with an embodiment of the present invention.

In an embodiment of the present disclosure, the system 1000 may operate by collecting project-specific data from stakeholders, which is then analysed and processed using machine learning algorithms. The system 1000 may generate personalized recommendations and insights based on industry best practices and regulatory requirements to enhance human-centric design processes in medical device manufacturing. The system 1000 may fosters collaboration and knowledge sharing among stakeholders and offers project management tools tailored for human factors projects. The system 1000 may continuously learn and refine its recommendations based on user evaluations and adjusts to changing industry trends. Data security measures may be implemented to protect sensitive information. The high-level steps or stages are as follows:

At 1002, collecting relevant project-specific data, including device attributes, user demographics, and intended use cases. This data serves as input for subsequent stages. At 1004, applying advanced machine learning algorithms to the collected data. These algorithms analyse and process the information, identifying patterns, correlations, and trends related to usability issues, user preferences, and potential risks. The system 1000 performs in-depth analysis and processing of the data using the AI algorithms. This stage involves applying sophisticated techniques to extract meaningful insights and draw conclusions based on the data patterns and correlations identified. The data security measures are in place to ensure the confidentiality and integrity of the collected data. This includes encryption, access controls, and other security mechanisms to protect sensitive information.

At 1006, generating recommendations and insights related to human factors considerations in the design and development of medical devices based on the analysis results. These recommendations cover various aspects such as user interface design, risk analysis, training approaches, and validation strategies. The system 1000 tailors the recommendations to each specific project based on the project-specific data input. This ensures that the generated recommendations are highly relevant and applicable to the unique characteristics of each medical device development project.

At 1008, facilitates collaboration and project management among stakeholders within the system 600. It provides a collaborative ecosystem where human factors practitioners, designers, researchers, and regulators can interact, share knowledge, and align their efforts. This fosters effective communication, coordination, and best practices implementation. Within the system 600, the stakeholders actively collaborate, exchange ideas, and work together to implement standardized human factors practices. This includes engaging in discussions, sharing resources, and aligning their efforts based on the SHF 2.0 framework and industry best practices.

At 1010, incorporating a continuous learning framework, allowing it to adapt and improve over time. It takes into account user evaluations, feedback, and adjustments to the project-specific data to refine its recommendations and insights. This iterative refinement process ensures that the system continuously evolves and stays up-to-date with the latest industry trends and research findings.

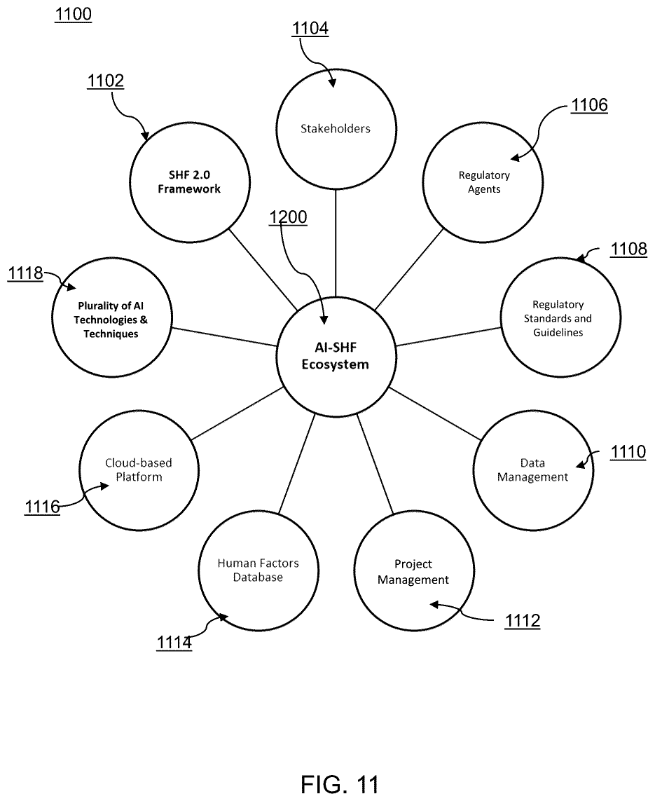

FIG. 11 illustrates an a visually organized representation of the AI-SHF ecosystem 1100, in accordance with an embodiment of the present invention. The AI-SHF ecosystem 1100 highlights the central importance of the AI-SHF system 600 and demonstrating interconnection between the stakeholders and components. The ecosystem 1100 may include a successful human factors (SHF) 2.0 framework 1102, providing a structured approach to human factors engineering in the medical device industry. It incorporates best practices, key success factors, and industry and regulatory standards/guidelines to guide stakeholders in optimizing human-centric design processes.

The ecosystem 1100 may include a plurality of stakeholder 1104 referring to individuals or entities who have a vested interest in the AI-SHF ecosystem 1100 and can directly or indirectly influence or be affected by its outcomes. The stakeholders 1104 may include human factors practitioners, medical device manufacturers, researchers, regulatory experts, patients, healthcare professionals, and others. They actively participate in the development, implementation, and use of the AI-SHF system 1800.

The ecosystem 1100 may include a plurality of regulatory bodies 1106 referring to entities responsible for establishing and enforcing regulations, guidelines, and standards related to medical devices and human factors engineering. They define the regulatory requirements that medical device manufacturers must adhere to ensure safety, efficacy, and quality. The regulatory bodies 1106, such as the FDA (Food and Drug Administration), EMA (European Medicines Agency), or other regional regulatory authorities, oversee the approval and regulation of medical devices.

Ecosystem 1100 may include a quality system 1108 as a set of organizational processes, procedures, and resources designed to ensure that medical devices meet quality standards, regulatory requirements, and user needs. It encompasses quality management, risk management, design controls, and other quality-related activities.

The ecosystem 1100 may include a plurality of data management protocols 1110. It involves managing project-specific data related to device attributes, user demographics, intended use cases, and other relevant information.

The ecosystem 1100 may include a project management system 1112 in form of a set of tools used to plan, execute, monitor, and control human factors projects within the AI-SHF ccosystem 1100. It includes project planning, task management, milestone tracking, risk analysis, and documentation management functionalities.

The ecosystem 1100 may include a database for human factors 1114 as a repository or database that stores information related to human factors engineering in the medical device industry.

The ecosystem 1100 may include a cloud-based system 1116 hosted on the cloud that provides stakeholders 1104 with access to the system 600 and its functionalities. It allows users to input project-specific data, view generated recommendations and insights, collaborate with other stakeholders, and access resources and tools.

The ecosystem 1100 may include a plurality of AI algorithms 1118 automating, augmenting, and optimizing the various dimensions and components of the SHF 2.0 framework. By harnessing the capabilities of artificial intelligence, the ecosystem aims to enhance efficiency, accuracy, and alignment with regulatory requirements throughout the human factors engineering lifecycle. Keyways the AI ecosystem operationalizes the SHF 2.0 framework include: and Documentation: AI algorithms leverage natural language processing (NLP) to extract relevant information from requirements, standards, and past project data. This enables the automated generation of accurate project plans, proposals, and documentation that align with SHF 2.0 best practices. AI-powered risk traceability and completeness management ensure comprehensive coverage of all necessary elements. Communication and Reporting: The ecosystem employs AI-assisted techniques to generate user-friendly reports and presentations tailored to the needs of diverse stakeholders, such as regulatory bodies, senior management, and product development teams. Natural language generation (NLG) capabilities allow the creation of clear, concise narratives that effectively communicate critical insights and findings.—Augmented People Management: The AI ecosystem can intelligently match personnel to project roles and responsibilities based on their qualifications and expertise. It conducts skills gap analyses and provides personalized training recommendations to ensure the project team is equipped with the necessary competencies. Conversational AI agents can also serve as virtual coaches, offering real-time guidance and support to the human factors engineering personnel.—Driven Tool and Methodology Selection: AI algorithms analyze project requirements and historical data to recommend the most suitable tools and methodologies for the human factors engineering activities. This ensures the optimal selection of techniques, aligned with SHF 2.0 best practices, while continuously learning and adapting based on project outcomes. Timing and Integration: By leveraging predictive analytics, the AI ecosystem can align human factors engineering activities with product development milestones, proactively identify and prioritize risks, and automatically adjust timelines to facilitate seamless integration with the broader product lifecycle. Regulatory Alignment: The AI ecosystem can perform gap analyses, automatically map SHF 2.0 practices to corresponding industry standards and regulatory guidelines (such as FDA's, IEC 62366-1), and provide intelligent guidance to ensure comprehensive compliance with evolving industry requirements. This holistic AI-powered ecosystem, organizations can operationalize the SHF 2.0 framework, streamlining human factors engineering processes, enhancing decision-making, and driving successful outcomes in medical device and combination product development.

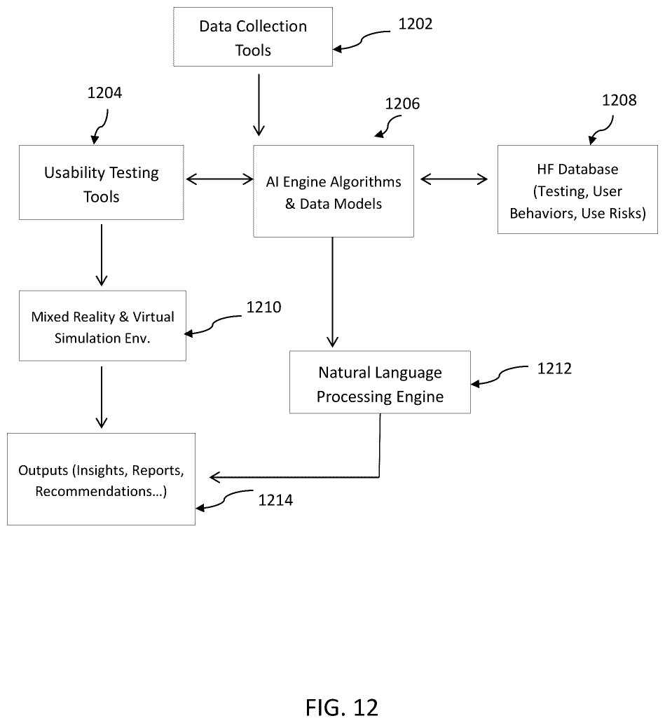

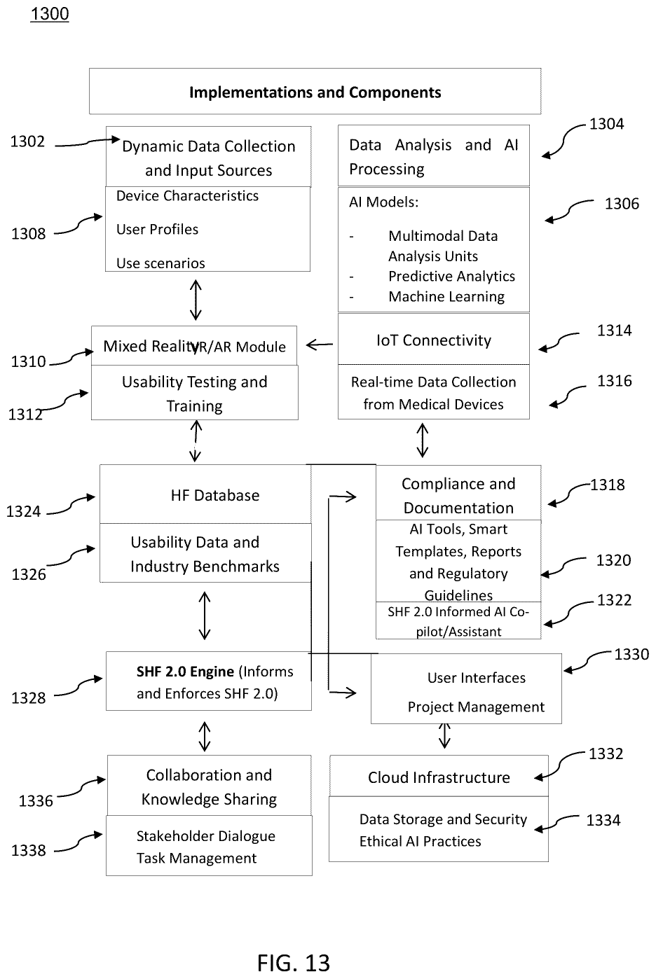

Referring to FIG. 12 and FIG. 13, shows a flow diagram of one exemplary embodiment of the AI-SHF System which may comprise Data Collection Tools 1202, Usability Testing Tools 1204, AI Engine Algorithms & Data Models 1206, HF Database 1208, Virtual Simulation Environment 1210, Natural Language Processing Engine 1212, Outputs 1214. The Data Collection Tools 1202 is used for gathering data such as user feedback, device logs, and regulatory guidelines, feeding directly into the AI Engine 1206 for processing. AI Engine 1206 is a Core component where AI algorithms and data processing occur. The AI Engine 1206 interacts directly with the Usability Testing Tools 1204 and the HF Database 1208. HF Database 1208 contains data on user behaviors, use risks, and usability testing outcomes, and supports the AI Engine in analysis and decision-making. The Usability Testing Tools 1204 interface for capturing and analyzing user interactions, feed results back to both the AI Engine 1206 and the HF Database 1208. The Virtual Simulation Environment 1210 provides a realistic simulation for usability testing, feeding data back to the AI Engine 1206 and Usability Testing Tools 1204. The Natural Language Processing Engine 1212 processes and interprets user inputs, aiding in categorizing feedback and detecting user sentiments. The AI Engine 1206 generates various outputs 1214 such as insights, reports and recommendations, which are essential deliverables of the system.

FIG. 13 illustrates an example of implementation components of the computer-implemented AI-SHF system integrating some functionalities, in accordance with an embodiment of the present invention. In an exemplary embodiment, the overreaching and comprehensive system is the AI-SHF system. The system may include and integrate data collection, analysis, compliance, user interface, collaboration tools, and cloud infrastructure to improve human factors engineering and design processes in medical device development. The system 1300 may incorporate data collection 1302, AI processing 1304, VR/AR modules/simulated environment 1310, usability testing and training 1312, AI models 1306, IoT connectivity 1314 for real time data collection from medical device 1316, compliance and documentation modules 1318 comprising templates, reports, regulatory compliance 1320, SHF 2.0 Informed AI Co-pilot/Assistant 1322, ensuring an integrative and holistic approach to human factors best practices, usability, safety, and regulatory compliance.

In an embodiment of the present disclosure, the human factors SHF 2.0 engine 1328 may be responsible for ensuring that all tasks and processes within the system adhere to human factors engineering principles and guidelines and functionalities may include centralized component that evaluates human factors aspects of the design and user interaction and implements SHF 2.0 framework principles. It may ensure compliance with industry standards and regulatory requirements.

In an embodiment of the present disclosure, the AI copilot may be an advanced AI-driven assistant that provides expert guidance, and may autonomously carry out complex human factors tasks, analysis and reporting, providing intelligent recommendations and support. The functionalities may include acting as an AI assistant to human factors practitioners, product development teams, and project managers, performing tasks such as risk identification, usability analysis, and proposing mitigation strategies, and utilizing advanced machine learning and multimodal analysis to provide insights. This copilot may provide training for HF professionals, manufacturer personnel, product end users, and other human factors-related training.

In an exemplary embodiment, the AI-SHF system may include the SHF 2.0 Framework as a foundational layer. The underlying principles guiding the entire AI-SHF system. It may Informs all other components, ensuring that each follows established human factors engineering standards and best practices. The AI models incorporated within the AI-SHF system include description of AI models, data analysis and AI processing, multimodal data analysis units, and handles real-time analysis of textual, visual, auditory, and contextual data. The implementation and components of the AI-SHF system includes data collection from the input sources to acquire data like device characteristics, user profiles, and use scenarios, data analysis and AI processing (with the AI Copilot delivering complex human factors tasks and performing multimodal data analysis and predictive analytics), VR/AR module to conduct usability testing as well as training in immersive, simulated environments; IoT connectivity to facilitate real-time data collection from interconnected systems and medical devices, centralized HFE database 1324 to stores usability data and industry benchmarks 1326, and compliance and documentation to provide templates, reports, and regulatory guidelines. The user interface 1330 may facilitate project management, collection of feedback, as well as facilitate user interactions. The collaboration and knowledge sharing 1336 feature may be a tool for stakeholder dialogue and task management 1338. It may enhance collaboration and knowledge dissemination among users, including external reviews of HF documentation, by regulatory agents. The cloud infrastructure 1332 may provide data storage, security, and ethical AI 1334 practices and may ensure robust cloud-based operations and data protection.

In an embodiment of the present disclosure, the SHF 2.0 framework may be established as the foundational layer, which underpins the entire system. All other components implement the SHF 2.0 principles, ensuring a cohesive approach to human factors engineering. The system may be situated within the data analysis and AI processing module, supported by SHF 2.0, performing high-level tasks informed by the framework. The HF engine may act as a central processing unit ensuring compliance with SHF 2.0 across system implementations.

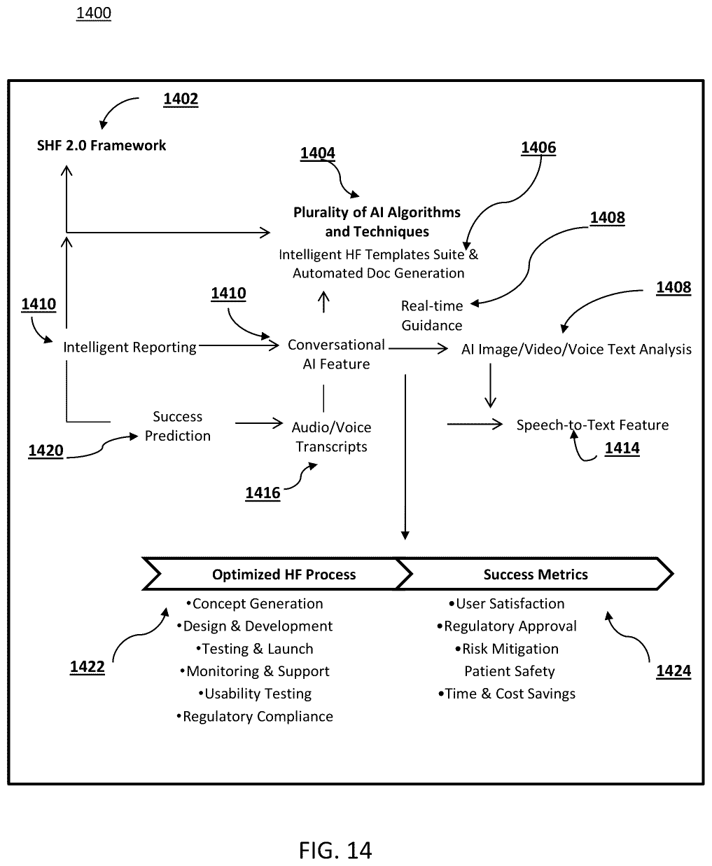

FIG. 14 illustrates a block diagram of a system 1400 for implementing the SHF 2.0 framework, combining multiple artificial intelligence (AI) technologies and techniques to enhance human factors engineering (HFE) processes, in accordance with one embodiment of the present invention. Central to the system is the Multimodality of the AI-SHF Core 1400, which leverages a “Plurality of AI Algorithms and Techniques” 1404 to drive intelligent functionalities throughout the system.

In this embodiment, the system 1400 illustrates the integration and interconnectivity of multiple AI-powered components and functionalities to streamline and optimize human factors engineering processes within the SHF 2.0 framework 1402, enabling effective compliance, risk management, and enhanced usability in medical device development.

The system 1400 includes a variety of interconnected subsystems or modules, and features, beginning with Intelligent Templates Suite & Automated Document Generation 1406, which leverages AI to generate comprehensive, regulation-aligned templates and documentation automatically. Real-time Guidance 1408 dynamically supports users by providing contextual and timely guidance based on AI-driven insights.

Conversational AI Chatbot Feature 1410 allows users to interact with the system through natural language processing, facilitating seamless communication with the AI-SHF Core. AI Image/Video/Voice Text Analysis 1412 converts multimodal inputs such as images, videos, and audio into structured text for further processing, supported by the Speech-to-Text Feature 1414, which ensures accurate transcription of spoken language into text form.

Additionally, the Audio/Voice Transcripts 1416 component integrates directly with both the conversational AI Chat Feature 1410 and the Speech-to-Text Feature 1414, enhancing the accessibility and usability of voice data. Intelligent Reporting 1418 employs sophisticated AI algorithms to identify patterns, detect anomalies, and extract valuable insights from gathered data, supporting the generation of comprehensive reports.

Success Prediction 1420 utilizes predictive analytics to forecast the success of various HFE initiatives, ensuring informed decision-making and effective risk management. The collective functionalities of the system 1400 contribute to Optimized Human Factors Processes 1422, which span across phases such as Concept Generation, Design & Development, Testing & Launch, Monitoring & Support, Usability Testing, and Regulatory Compliance.

Success Metrics 1424 are established to measure key outcomes, including User Satisfaction, Regulatory Approval, Risk Mitigation, Patient Safety, and Time & Cost Savings. These metrics ensure that the system 1400 delivers tangible benefits throughout the lifecycle of medical device development and integration.

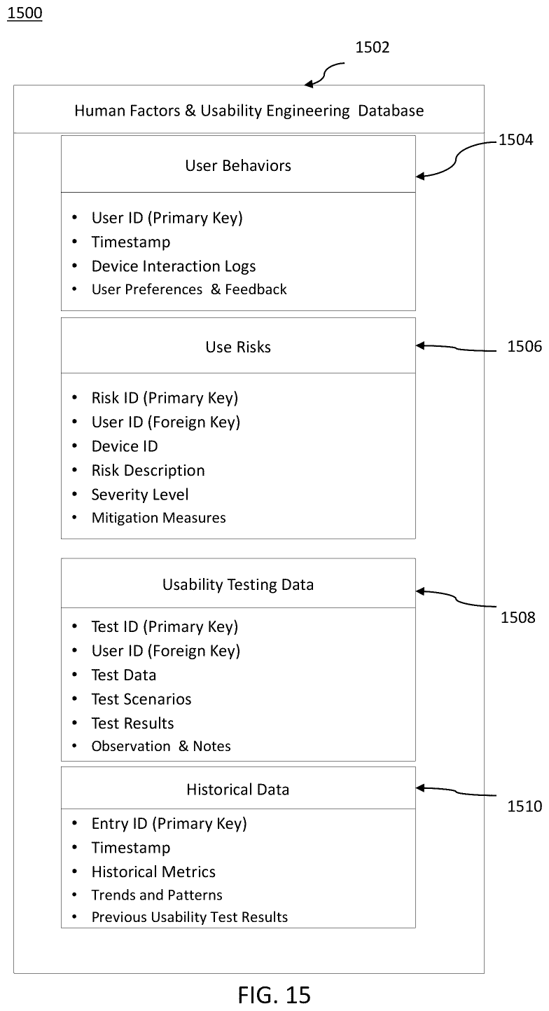

Referring to FIG. 15, the representation shows one embodiment of the structure of the human factors and usability database 1502, illustrating key tables, fields, and relationships. The HF/U database 1502 may comprise User behaviour 1504, Use risks 1506, Usability testing data 1508, and historical data 1510 which are organized and interlinked within the database, providing robust support for predictive analytics.

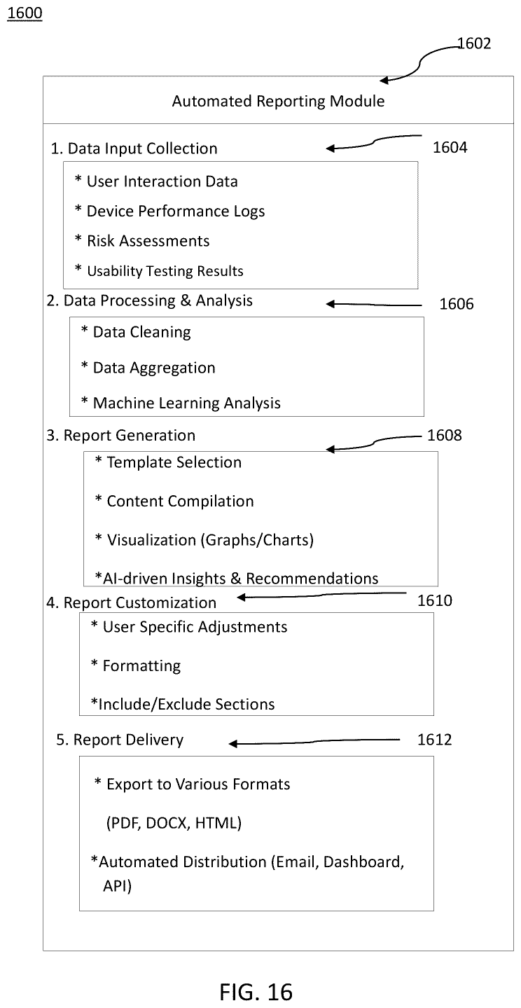

Referring to FIG. 16, a comprehensive and systematic flow 1600 of the Automated Reporting Module 1602 within the system. The Automated Reporting Module 1602 comprises data input collection 1604, data processing and analysis 1606, followed by structured report generation 1608 and customization 1610, to final delivery 1612 in various formats. The flow diagram 1600 highlights the module's capability to produce detailed, AI-driven reports that are tailored to user needs.

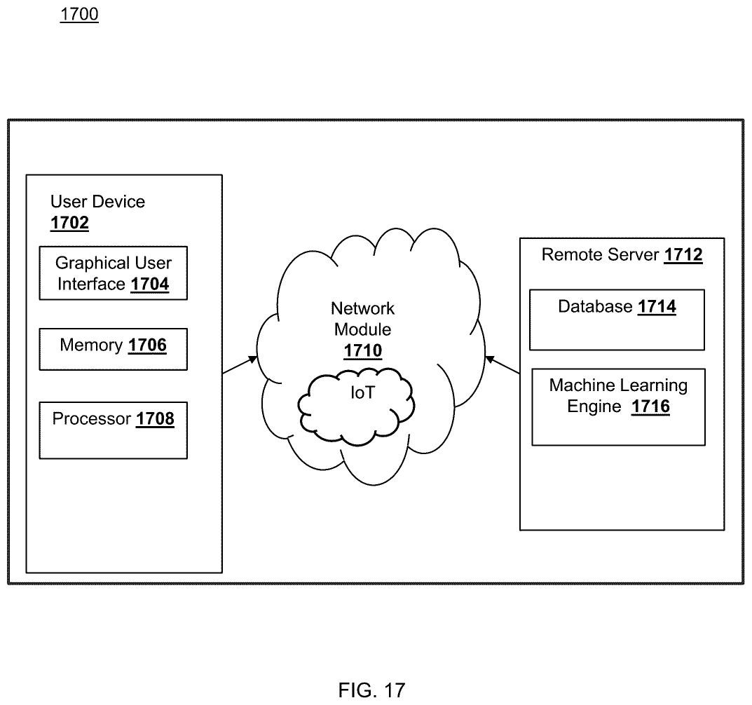

FIG. 17 illustrates a block diagram of a system 1700 for intelligent integration of human factors & usability engineering to life sciences products and systems development, in accordance with one embodiment of the present invention. The user may comprise a user device 1702 having a graphical user interface 1704, memory 1706, and a processor 1708, a network module 1710, and a cloud server 1712 having a database 1714 and a machine learning engine 1716. In the embodiment, the network module 1710 may comprise IoT. The IoT would allow connectivity to devices and systems, for real time data sources, and not only medical devices but also integration with other solutions that are part of product development.

The user device 1702 acts as the entry point for users to interact with the AI-SHF system 1700, detailed in another section. It has a graphical user interface 1704 that provides a visual and interactive environment for users to navigate the system's functionalities. The user device 1702 communicates with a remote server 1712, which stores data within the database 1714. The user device 1702 relies on a processor 1708 and memory 1706 to perform necessary computations and store data locally. Additionally, a network module 1710 facilitates communication between the user device 1702 and the cloud-based infrastructure 1704 in FIG. 17.

In an embodiment of the present disclosure, the system 1700 may include a plurality of user devices 1702 accessible to a user or a plurality of stakeholder. The Memory 1706 stores data locally on the user device 1702. This allows the processor 1708 to access information needed to perform computations and enables the user device 1702 to function without constant communication with the remote server 1712.

The processor 1708 handles computations needed by the user device 1702. It works in conjunction with memory 1706 to store and access data required for various functionalities. This enables the user device 1702 to run the graphical user interface 1704 and interact with the AI-SHF 2.0 system 1700.

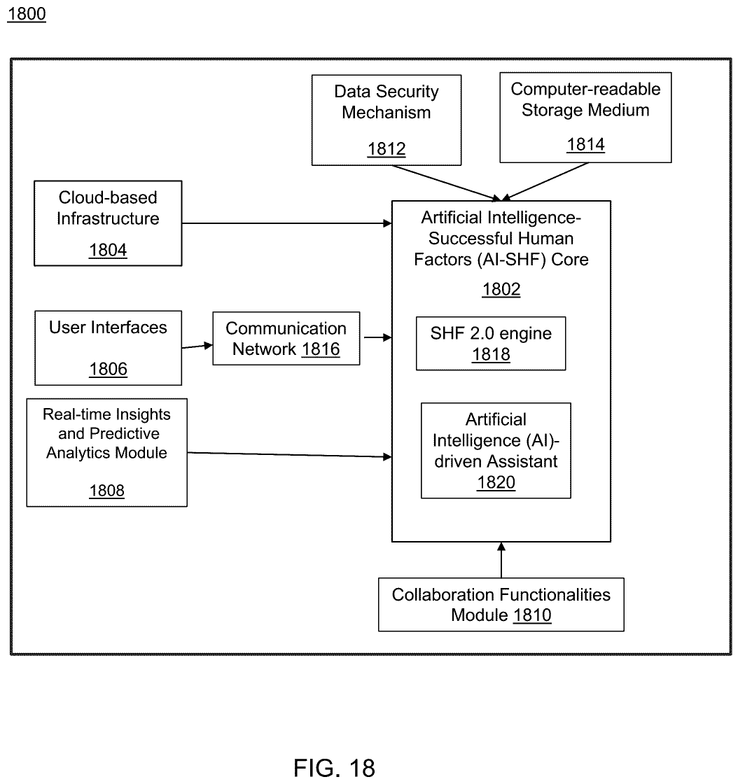

The network module 1710 acts as the bridge between the user device 1702 and the cloud-based infrastructure in the AI-SHF system 1700. It facilitates a two-way flow of information, enabling users to send data about the medical device, user demographics, and intended use cases. This data is then transmitted securely to the cloud where the AI-SHF Core 1802 resides, as in FIG. 18. The network module 1710 also allows users to receive recommendations generated by the AI-SHF Core and access project updates and collaborate with other stakeholders. This continuous exchange of information ensures that users have the latest insights and can make informed decisions throughout the human factors' validation process. The network module 1710 plays a critical role in ensuring seamless communication within the AI-SHF 2.0 system.

The remote server 1712 acts as a secure storage vault within the AI-SHF system 1700. It houses a database 1714 that stores critical information for the human factors projects process. This data can include details about the medical device under development, user demographics, and project-specific notes. The user device 1702 communicates with the remote server 1712 to access and update this information. By centralizing data storage, the remote server 1712 ensures all authorized users have access to the latest information, fostering collaboration and informed decision-making. Additionally, the remote server 1712 plays a vital role in maintaining data integrity. Robust security measures safeguard sensitive information, ensuring regulatory compliance and protecting user privacy.

Users interact with the AI-SHF system 1700 through a graphical user interface (GUI) 1704 on a user device 1702. This user device 1702 can be a computer, tablet, or any other device with a suitable interface. The graphical user interface (GUI) 1704 provides a user-friendly environment for data input, visualization of recommendations, and interaction with the system's functionalities.

The user device 1702 relies on a processor 1708 and memory 1706 to process information and perform necessary computations. The memory 1706 stores data locally on the device, enabling the user device 1702 to function without constant communication with a remote server 1712. When an internet connection is available, a network module 1710 within the user device 1702 facilitates communication with the cloud-based infrastructure 1704 of the AI-SHF system 1700. This allows users to upload data, receive recommendations, and collaborate with other stakeholders involved in the human factors process. The cloud-based infrastructure 1704 serves as the backbone of the AI-SHF system 1700. This secure and scalable environment houses various components that work together to analyze data and generate recommendations for medical device development. A remote server 1712 within the cloud infrastructure stores data in a database 1714. This data can include information about the medical device under development, user demographics, project details, and any other information relevant to the human factors' validation process.

FIG. 18 illustrates a block diagram of a computer-implemented AI-SHF system 1800 intelligent integration of human factors & usability engineering to life sciences products and systems development, in accordance with one embodiment of the present invention. The system 1800 may comprise an AI-SHF Core 1802, a cloud-based infrastructure 1804, a plurality of user interfaces 1806, a real-time insights and predictive analytics module 1808, a collaboration functionalities module 1810, and a data security mechanism 1812, a computer-readable storage medium integrated 1814, and a communication network 1816.

The system 1800 may be comprising an AI-SHF Core module 1802 combining; a plurality of the artificial intelligence algorithm, a successful human factors (SHF) 2.0 framework integration module incorporating therewithin the principles and guidelines of the successful human factors (SHF) framework to ensure a comprehensive and structured approach to human factors projects throughout the product development lifecycle (from discovery or concept development to post-market surveillance such as complaints analysis). The AI-SHF Core module 1802 may further include a SHF 2.0 engine 1818 may be configured to ensure adherence to human factors principles and the successful human factors (SHF) 2.0 framework across all tasks and supports regulatory compliance and industry best practices. The AI-SHF Core module 1802 may further include an artificial intelligence (AI)-driven assistant 1820 which may be configured to provide guidance to enhance human factors engineering projects and decision-making thought product development, and perform complex tasks autonomously, guided by the principles enforced by the SHF 2.0 engine.

The AI-SHF Core module 1802 may use a plurality of machine learning algorithms and techniques to analyze and process large datasets to identify patterns, correlations, risks and trends and enable generation of personalized recommendations and insights based on the analysis of project-specific data and industry knowledge. The AI-SHF Core module 1802 may leverage the artificial intelligence algorithms to analyses and interpret regulatory guidance documents, providing a plurality of stakeholder with clear and consistent recommendations for regulatory compliance according to their specific needs. The system 1800 may also be comprising a cloud-based infrastructure 1804 operationally coupled to AI-SHF Core module 1802, the cloud-based infrastructure 1804 enables the stakeholders to securely access and share project-specific data, tools, and resources, wherein the cloud-based infrastructure is hosted on cloud servers to allow scalability, accessibility, and seamless collaboration among the stakeholders.

Cloud-based infrastructure 1804 may be operationally coupled to AI-SHF Core module 1802 and the cloud-based infrastructure 1804 enables the stakeholders to securely access and share project-specific data, tools, and resources. Cloud-based infrastructure 1802 may be hosted on cloud servers to allow scalability, accessibility, and seamless collaboration among the stakeholders.

The plurality of user interface 1806 may be operationally coupled to the AI-SHF 602 and the user interfaces 1806 operable to allow the stakeholders to interact with the system 1800. The user interfaces 1806 act as a visual and interactive component.

The real-time insights and predictive analytics module 1808 may be operationally coupled to the AI-SHF 1802 and the real-time insights and predictive analytics module 1808 configured to provide insights to help stakeholders make informed decisions, anticipate potential issues, and perform predictive analytics based on the analysis of project-specific data.

The collaboration functionalities module 1810 may be operationally coupled to the AI-SHF 1802, the collaboration functionalities module 1810 configured to facilitate communication, knowledge sharing, and coordination among stakeholders, and enable stakeholders to collaborate, exchange ideas, and work together in implementing human factors practices and complying with regulatory guidelines.

The data security mechanism 1812 may be integrated with the AI-SHF 1802 and the data security mechanism ensures the confidentiality, integrity, and protection of project-specific data and user interactions within the system 1800.

The computer-readable storage medium 1814 may be integrated with the AI-SHF Core 1802 and the computer-readable storage medium 1814 acting as a computer-readable storage medium or device to store the instructions, algorithms, and data of the system 1700.

The communication network 1816 may be linking the user interfaces 1806 to other components of the system and the communication network 1816 configured to provide internet connectivity. The AI-SHF Core module 1802 may use a plurality of machine learning algorithm to analyze and process large datasets to identify patterns, correlations, and trends and enable generation of personalized recommendations and insights based on the analysis of project-specific data and industry knowledge.

The user interface 1806 may provide intuitive and user-friendly ways to input project-specific data, view recommendations and insights, and collaborate with other stakeholders using a plurality of input functionality.

The input functionalities may be the features and tools that enable stakeholders to input project-specific data into the AI-SHF Core module 1802 and provides structured input fields and forms allowing the stakeholders to enter device attributes, user demographics, intended use cases, and other relevant information.

The data security mechanism 1812 may include encryption, access controls, and secure data storage protocols to safeguard sensitive information. The system 1800 may further include a real-time feedback and iteration module configured to enable capturing real-time feedback and incorporating iterative improvements by allowing stakeholders to review and refine the human factors projects strategies based on artificial intelligence (AI)-generated recommendations generated by the artificial intelligence-driven recommendation module.

The system 1800 may also include an artificial intelligence-driven recommendation module operationally coupled to the real-time feedback and iteration module and the artificial intelligence-driven recommendation module has self-learning capabilities designed to refine recommendations over time by incorporating user evaluations and adjustments to project-specific data, ensuring continuous improvement and alignment with regulatory requirements.

The real-time feedback and iteration module may employ natural language processing (NLP) for a user feedback analysis to analyse user feedback collected from the sources such as surveys, social media, and customer support interactions.

The system 1800 may also offer performance monitoring and analytics capabilities to track the effectiveness of human factors projects strategies, identify areas for improvement, and measure the impact on product success and user satisfaction.

The AI-SHF Core module 1802 may perform intelligent data analysis to analyze vast amounts of data collected during human factors projects by utilizing a plurality of machine learning algorithms.

The AI-SHF Core 1802 may replicate real-world scenarios and allow for extensive testing of medical devices in various use-case scenarios through a plurality of virtual simulations helping to identify usability issues, evaluate design alternatives, and validate the effectiveness of human factors interventions before building the physical prototypes.

The AI-SHF Core 1802 may provide a plurality of intelligent decision support tool for human factors practitioners and project managers for making informed decisions regarding human factors strategies, resource allocation, timeline management, and risk mitigation.

The system 1800 automates the generation of documentation and reporting required for human factors projects by extracting relevant information from project data and applying natural language generation (NLG) techniques. The stakeholders may include human factors practitioners, designers, researchers, regulatory experts, communication channels, knowledge sharing features, resource library, and coordination mechanisms as in FIG. 11.

The computer-readable storage medium 1814 may store directives that, upon execution by a processor, enable the enhancing human-centric design process in medical device manufacturing and the process includes acquiring input data inclusive of device specifications, user demographics, and intended use cases. The process also includes utilizing machine learning algorithms to analyze and interpret regulatory guidance documents, providing clear and consistent recommendations for regulatory compliance. The process also includes generating enhanced design recommendations derived from the analysis, addressing challenges related to user group definition and recruitment, data leveraging across regulatory jurisdictions, investment funds for developing countries (IFU) development and validation, and equivalency issues. The process also includes delivering the enhanced design recommendations to stakeholders for consideration and implementation, with iterative refinement based on user evaluations and adjustments to project-specific data.

The cloud-based infrastructure 1804 may further consist of database 1714 as in FIG. 17 designed for storing device specifications, user demographics, and intended use scenarios. The cloud-based infrastructure 1804 may further consist of a machine learning engine 1716 (FIG. 17) incorporating a plurality of machine learning algorithms embedded within the infrastructure to analyze and interpret regulatory guidance documents, providing clear and consistent recommendations for regulatory compliance. The cloud-based infrastructure 1804 may further consist of a plurality of procurement and acquisition functionality to perform project-specific data acquisition including, device attributes, user demographics, intended use cases, use-related risk traceability functionalities. The cloud-based infrastructure 1804 may further consist of a means for user communication to enable a plurality of stakeholders to input and retrieve project-specific data, view the generated recommendations, and collaborate with other users on challenges related to user group definition and recruitment, data leveraging across regulatory jurisdictions, investment funds for developing countries (IFU) development and validation, and equivalency issues. The cloud-based infrastructure 1804 may further consist of a plurality of security mechanisms implemented to safeguard the confidentiality and integrity of the stored data and user interactions within the system, ensuring regulatory compliance and data protection.

The machine learning engine may incorporate an ethical artificial intelligence (AI) practice protocol for ensuring transparency, fairness, and accountability in the leveraged artificial intelligence (AI) algorithms and data usage. The database may be a human factors database configured to store information related to human factors engineering in the medical device industry, and contain data on user profiles, user interface design, risk analysis, training approaches, validation strategies, and other human factors-related aspects.

In an embodiment of the present disclosure, the AI-SHF system 1800 in FIG. 18, leverages a machine learning engine 1716, which resides within the cloud-based infrastructure and plays a critical role in analyzing data. The machine learning engine 1716 utilizes machine learning algorithms to extract insights from data and identify patterns and trends in FIG. 17.

In one embodiment of the present disclosure, the Core of the AI-SHF 2.0 system 1800 is the AI-SHF Core module 1802. This module integrates the machine learning engine 1716 with the principles of the SHF 2.0 framework. By analyzing data on medical devices, user demographics, and intended use cases, the AI-SHF Core module 1802 generates personalized recommendations for human factors projects throughout the entire development process. These recommendations are delivered to users through the user interfaces.

In an embodiment of the present disclosure, the system 1800 also employs the real-time insights and predictive analytics module 1808. The real-time insights and predictive analytics module 1808 continuously analyze data within the system and generates real-time insights and predictions to aid stakeholders in decision-making. The real-time insights and predictive analytics module 1808 considers user interactions and project-specific information to deliver valuable forecasts that can optimize the human factors projects process.

In an embodiment of the present disclosure, to foster collaboration among stakeholders, the system 1800 incorporates the collaboration functionalities module 1810. The collaboration functionalities module 1810 provides features for communication, knowledge sharing, and coordinated work on human factors projects tasks. Stakeholders can use it to discuss challenges, share best practices, and ensure everyone is on the same page throughout the medical device development cycle.

In an embodiment of the present disclosure, the data security is paramount within the AI-SHF 2.0 system 1800. The data security mechanism 1812 safeguards sensitive information. This critical component employs encryption, access controls, and secure data storage protocols to protect user data, project details, and any other confidential information handled by the system 1800.

In an embodiment of the present disclosure, the computer-readable storage medium 1814 serves as the memory 1706 of the AI-SHF 2.0 system 1800. It stores essential elements like instructions, algorithms, and data used by the system to function. The computer-readable storage medium 1814 allows the system 1800 to operate effectively and deliver consistent recommendations for medical device development.

In an embodiment of the present disclosure, to ensure seamless data exchange within the system, the communication network 1816 facilitates communication between various components residing in the cloud-based infrastructure. The communication network 1816 enables the exchange of data between the AI-SHF Core module 1802, the user interfaces 1806, and other functionalities, allowing the system to function as a cohesive system.

The embodiments, features, and implementations described in the present disclosure are intended to be illustrative examples, and are not meant to limit the full scope of protection afforded by this invention. Any person skilled in the relevant art shall recognize that the technical principles and innovations disclosed herein may be applied, combined, substituted, or modified in various ways to arrive at other embodiments that fall within the inventive concepts described.

Scope of the present disclosure shall not be restricted or constrained by the specific examples provided. Rather, the full breadth of protection shall be determined by the appended claims, which define the novel and inventive aspects that are central to this disclosure. any variations, adaptations, or replacements that a person of ordinary skill could reasonably conceive based on the disclosed technical information shall also be encompassed within the protective scope. This includes, but is not limited to, making changes to materials, dimensions, configurations, processes, or other parameters, as long as the fundamental principles and core innovations are preserved.

The embodiments and descriptions herein are not intended to be an exhaustive listing of all possible implementations. The disclosure enables a wide range of future developments, improvements, and alternative embodiments that build upon the foundational technical advancements presented. It is understood that various omissions and substitutions of equivalents are contemplated as circumstance may suggest or render expedient, but such are intended to cover the application or implementation without departing from the spirit or scope of the claims of the present invention.

Therefore, the protection scope shall extend to cover any such derivative works or modifications that fall within the spirit and intent of the inventive concepts. summary, the protection scope of the present disclosure shall be interpreted broadly, limited only by the language and scope of the associated patent claims, and shall not be unduly constrained by the specific examples or embodiments described in the written description.

### REFERENCES

[1] U.S. Food and Drug Administration, “Medical Device Recalls”, Accessed: May 27, 2024. [Online]. Available: https://www.accessdata.fda.gov/scripts/cdrh/cfdocs/cfres/res.cfm
[2] FDA and CDRH, “Applying Human Factors and Usability Engineering to Medical Devices—Guidance for Industry and Food and Drug Administration Staff,” FDA Guidance. [Online]. Available: https://www.fda.gov/media/80481/download
[3] K. M. Rojas, N. Shararch, L. Cosler, and D. L. Santos, “Considering the Dynamics of FDA Human Factors Validation Requirement: Implications of Failure and Need to Ensure Project Success—A Conceptual Framework,” Proceedings of the International Symposium on Human Factors and Ergonomics in Health Care, vol. 8, no. 1, pp. 234-247, September 2019, doi: 10.1177/2327857919081057.
[4] K. M. Rojas, L. Cosler, and D. L. Santos, “Understanding Practices and Critical Success Factors of FDA Human Factors Validation Projects—Preliminary Findings.” in Proceedings of the International Symposium on Human Factors and Ergonomics in Health Care, SAGE Publications, 2020.
[5] K. M. Rojas, L. Cosler, and D. L. Santos, “A Narrative Review of FDA Human Factors Validation Requirement: The Needs of Key Stakeholders and Proposal of an Industry (Human Factors Service Providers) Maturity Assessment Tool,” Proceedings of the International Symposium on Human Factors and Ergonomics in Health Care, vol. 8, no. 1, pp. 222-233, September 2019, doi: 10.1177/2327857919081056.
[6] K. M. Rojas, “Developing an Industry-Focused Maturity Assessment Tool Based on Key Factors Critical to Quality and Success in FDA Human Factors Validation Projects—Overview,” in Proceedings of the International Symposium on Human Factors and Ergonomics in Health Care, in Developing and Testing an Industry-focused (Human Factors Service Providers) PM Maturity Assessment Tool for Medical Devices and Combination Products Validation Projects. SAGE Publications, 2020.
[7] K. M. Rojas and D. Santos, “Project Management Practices and Key Factors for Success in FDA Human Factors Validations of Medical Devices and Combination Products.” United States—New York, 2020. [Online]. Available: http://proxy.binghamton.edu/login?url=https://www.proquest.com/dissertations-theses/project -management-practices-key-factors-success/docview/2436414382/se-2?accountid=14168
[8] CMMI Institute, “CMMI Institute—Medical Device Discovery Appraisal Program,” Website of the CMMI Institute. Accessed: Jan. 2, 2019. [Online]. Available: https://cmmiinstitute.com/medicaldeviceapplication
[9] Center for Devices and Radiological Health. (2022). Content of Human Factors Information in Medical Device Marketing Submissions: Draft Guidance for Industry and Food and Drug Administration Staff. Retrieved from https://www.fda.gov/regulatory-information/search-fda-guidance-documents/content -human-factors-information-medical-device-marketing-submissions.

What is claimed is:

1. A system for enhancing and optimizing human factors and usability engineering in life sciences and healthcare product life cycle using artificial intelligence technologies, the system comprising:
integrating a plurality of AI algorithms and techniques to operationalize the components and principles of the SHF 2.0 framework, employing an AI-SHF system that includes:
an AI-SHF Core module incorporating a plurality of AI algorithms and techniques, including, but not limited to machine learning, natural language processing (NLP), computer vision, and data models;
a SHF 2.0 engine configured to:
ensure adherence to human factors and usability engineering standards and guidelines, including the successful human factors (SHF) 2.0 framework across all activities and tasks; and
supports customized global regulatory compliance and industry best practices; and
an artificial intelligence (AI)-driven conversational assistant configured to:
guide and enhance human factors projects, activities, and decision-making; and perform complex tasks autonomously, guided by the principles enforced by the SHF 2.0 engine;
automation modules utilizing Generative AI (GenAI) technologies to automate tasks, generate summaries, and produce reports, including usability testing results, risk assessments, and user interface design recommendations;
a cloud-based infrastructure operationally coupled to AI-SHF Core, the cloud-based infrastructure enables the stakeholders to securely access and share project-specific data, tools, and resources,
wherein the cloud-based infrastructure is hosted on cloud servers to allow scalability, accessibility, and seamless collaboration among the stakeholders;
a plurality of user interfaces operationally coupled to the AI-SHF Core module, the user interfaces operable to allow the stakeholders to interact with the system, wherein the user interfaces act as a visual and interactive component;
a real-time insights and predictive analytics module operationally coupled to the AI-SHF Core, the real-time insights and predictive analytics module configured to:
provide insights to help stakeholders make informed decisions, anticipate potential risks and issues; and
perform predictive analytics based on the analysis of project/device-specific data;
a collaboration functionalities module operationally coupled to the AI-SHF Core, the collaboration functionalities module configured to:
facilitate communication, knowledge sharing, coordination and collaboration among stakeholders including regulatory experts to regulatory reviews); and
enable stakeholders to collaborate, exchange ideas, and work together in standardizing, implementing human factors practices and complying with regulatory guidelines;
a data security mechanism integrated with the AI-SHF, the data security mechanism ensures the confidentiality, integrity, and protection of project-specific data and user interactions within the system;
a computer-readable storage medium integrated with the AI-SHF, the computer-readable storage medium acting as a computer-readable storage medium or device to store the instructions, algorithms, and data of the system;
a communication network linking the user interfaces to other components of the system, the communication network configured to provide internet connectivity.

2. The system of claim 1, wherein the AI-SHF Core module uses a plurality of machine learning algorithms to analyse and process large datasets to identify patterns, correlations, and trends and enable generation of personalized recommendations and insights based on the analysis of project-specific data and industry knowledge.

3. The system of claim 1, wherein the AI-SHF Core leverages the artificial intelligence algorithm to continuously analyze and interpret applicable regulatory guidance documents, providing a plurality of stakeholder with up-to-date, customized, clear and consistent recommendations for regulatory compliance.

4. The system of claim 1, wherein the user interface provides intuitive and user-friendly ways to input device or project-specific data, view recommendations and insights, and collaborate with other stakeholders using a plurality of input functionality.

5. The system of claim 4, wherein the input functionalities are features and tools that enable stakeholders to input project-specific data into the AI-SHF Core and provides structured input fields and forms allowing the stakeholders to enter device attributes, user demographics, intended use cases, and other relevant information.

6. The system of claim 1, wherein the data security mechanism includes encryption, access controls, and secure data storage protocols to safeguard sensitive information.

7. The system of claim 1, wherein the system further includes a real-time feedback and iteration module configured to enable capturing real-time feedback and incorporating iterative improvements by allowing stakeholders to review and refine the human factors projects strategies based on artificial intelligence (AI)-generated recommendations generated by the artificial intelligence-driven recommendation module.

8. The system of claim 7, wherein the system also includes an artificial intelligence-driven recommendation module operationally coupled to the real-time feedback and iteration module and the artificial intelligence-driven recommendation module has self-learning capabilities designed to refine recommendations over time by incorporating user evaluations and adjustments to project-specific data, ensuring continuous improvement and alignment with regulatory requirements.

9. The system of claim 7, wherein the real-time feedback and iteration module may employ natural language processing (NLP) for a user feedback analysis to analyse user feedback collected from the sources such as surveys, social media, and customer support interactions.

10. The system of claim 1, wherein the system also offers performance monitoring and analytics capabilities to track the effectiveness of human factors projects strategies, identify areas for improvement, and measure the impact on product success and user satisfaction.

11. The system of claim 1, wherein the AI-SHF Core performs intelligent data analysis to analyse vast amounts of data collected during human factors projects by utilizing a plurality of machine learning algorithms.

12. The system of claim 1, wherein the AI-SHF Core replicates real-world scenarios and allow for extensive testing of medical devices in various use-case scenarios through a plurality of virtual simulations helping to identify usability issues, evaluate design alternatives, and validate the effectiveness of human factors interventions before building the physical prototypes.

13. The system of claim 1, wherein the AI-SHF Core provides a plurality of intelligent decision support tool for human factors practitioners and project managers for making informed decisions regarding human factors strategies, resource allocation, timeline management, and risk mitigation.

14. The system of claim 1, wherein the system automates the generation of documentation and reporting required for human factors projects by extracting relevant information from project data and applying natural language generation (NLG) techniques.

15. The system of claim 1, wherein the stakeholders include human factors practitioners, designers, researchers, regulatory experts, communication channels, knowledge sharing features, resource library, and coordination mechanisms.

16. The system of claim 1, wherein the computer-readable storage medium storing directives that, upon execution by a processor, enable the enhancing human-centric design process in medical device manufacturing and the process includes:
acquiring input data inclusive of device specifications, user demographics, and intended use cases;
utilizing machine learning algorithms to analyze and interpret regulatory guidance documents, providing clear and consistent recommendations for regulatory compliance;
generating enhanced design recommendations derived from the analysis, addressing challenges related to user group definition and recruitment, data leveraging across regulatory jurisdictions, investment funds for developing countries (IFU) development and validation, and equivalency issues; and
delivering the enhanced design recommendations to stakeholders for consideration and implementation, with iterative refinement based on user evaluations and adjustments to project-specific data.

17. The system of claim 1, wherein the cloud-based infrastructure further consisting of:
a database designed for storing device specifications, user demographics, and intended use scenarios;
a machine learning engine incorporating a plurality of machine learning algorithms embedded within the infrastructure to analyse and interpret regulatory guidance documents, providing clear and consistent recommendations for regulatory compliance;
a plurality of procurement and acquisition functionality to perform project-specific data acquisition including, device attributes, user demographics, intended use cases, use-related risk traceability functionalities;
a means for user communication to enable a plurality of stakeholders to input and retrieve project-specific data, view the generated recommendations, determining specific regulatory requirements for each targeted region based on an automated analysis of regulatory guidelines; and collaborate with other users on challenges related to user group definition and recruitment, data leveraging across regulatory jurisdictions, (IFU) development, and equivalency issues (among others);
a plurality of security mechanisms implemented to safeguard the confidentiality and integrity of the stored data and user interactions within the system, ensuring regulatory compliance and data protection.

18. A system of claim 17, wherein the machine learning engine incorporates an ethical artificial intelligence (AI) practice protocol for ensuring transparency, fairness, and accountability in the leveraged artificial intelligence (AI) algorithms and data usage.

19. The system of claim 17, wherein the database is a human factors database configured to:
store information related to human factors engineering in the medical device industry; and
contain data on user profiles, user interface design, risk analysis, training approaches, validation strategies, and other human factors-related aspects.

20. A computer-implemented method for conducting human factors and usability engineering projects in the life sciences and healthcare field, such as for medical devices and combination products, the method comprising:
receiving input data related to a medical device project, including device characteristics, user profiles, and intended use scenarios;
using artificial intelligence algorithms to analyse the input data and generate personalized recommendations for human factors projects, considering factors such as user interface design, risk analysis, and training approaches;
incorporating the principles and guidelines of the successful human factors (SHF) 2.0 framework into the human factor's validation process;
providing real-time feedback and facilitating iterative improvements based on the artificial intelligence (AI)-generated recommendations;
supporting regulatory compliance by providing guidance, GenAI, templates, and documentation related to human factors projects submissions; and
leveraging multimodal capabilities, mixed reality, VR and AR, to simulate and assess usability in various scenarios and environments including in real-time.

21. The method of claim 20, wherein the multimodal analysis includes multiple forms of data, such as textual, visual, auditory, and contextual data analysis.

22. The method of claim 20, the method further comprising:
monitoring the performance of human factors projects strategies, identifying areas for improvement, and measuring their impact on product success and user satisfaction;
adapting to accommodate a wide range of medical device projects and evolving industry standards and regulations;
analysing data collected during human factors projects to identify patterns, detect anomalies, and extract insights;
conducting virtual simulations to replicate real-world scenarios, identify usability issues, evaluate design alternatives, and validate the effectiveness of human factors interventions; and
utilizing internet of things (IoT) connectivity for real-time data collection from interconnected systems and medical devices, contributing to a centralized database of user behaviour data and use-context information.

23. The method of claim 22, the method further comprising:
analysing user feedback using natural language processing (NLP) to understand user sentiments and identify recurring issues;
providing intelligent decision support tools for human factors practitioners and project managers, based on project data, regulatory requirements, and industry best practices;
automating the generation of documentation and reporting for human factors projects; and
continuously learning from new data, emerging trends, and regulatory updates to ensure compliance and to improve decision-making capabilities over time.

24. The method of claim 23, the method further comprising:
facilitating collaboration among stakeholders, allowing them to share best practices, exchange knowledge, and learn from each other's experiences;
managing human factors projects, including task management, milestone tracking, resource allocation, and collaboration features;
supporting the identification, assessment, and mitigation of use-related risks associated with medical devices; and
seamlessly integrating with existing systems and tools used in the medical device industry, such as quality management systems (QMS) and design control systems.

25. The system of claim 6, wherein the data security mechanism includes encryption, access controls, and secure data storage protocols to safeguard sensitive information, further comprising automated threat detection and real-time security response capabilities for proactive data protection.

26. The system of claim 3, wherein the AI-SHF Core leverages the artificial intelligence algorithm to analyze and interpret applicable regulatory guidance documents, further comprising automated updates and notifications for regulatory changes to guide stakeholders in ensuring ongoing compliance.

27. The system of claim 10, wherein the system also offers performance monitoring and analytics capabilities to track the effectiveness of human factors projects strategies, further comprising AI-driven anomaly detection algorithms for early identification of potential issues and deviations in project performance to ensure success.

28. The system of claim 13, wherein the system provides a plurality of intelligent decision support tools for human factors practitioners and project managers, further comprising a predictive maintenance module utilizing historical data and machine learning algorithms to forecast potential human factors issues and pre-emptively address them.

29. The system of claim 15, wherein the mixed reality module including VR/AR conducts real-world scenario replication, usability issue identification before prototyping, and design alternatives evaluation, further comprising interactive simulations for stakeholder engagement and user feedback integration, enhancing design decision-making processes.

30. The system of claim 1, further comprising a Product Team Training Module for offering AI-driven training modules for product development teams to educate on human factors engineering (HFE) principles, compliance requirements, and best practices.

31. The system of claim 1, further comprising a Regulatory Trends Module configured to utilize AI to continuously analyze and predict changes in regulatory landscapes, ensuring adaptive, customize compliance with new regulations.

32. The system of claim 1, further comprising an Interoperability Module for ensuring seamless compatibility and interoperability with other AI-driven healthcare systems.

33. The system of claim 1, further comprising a Real-Time Insight Module for incorporating mechanisms for continuous monitoring and feedback loops using AI to refine and improve human factors strategies based on real-time user interactions and data analysis.

34. The system of claim 1, further comprising an AI Virtual Assistant Module for providing real-time support and guidance to users during device interactions, enhancing usability and user experience through AI-driven guidance and virtual assistants.

35. The system of claim 1, further comprising a Use Error & Risk Analysis Module configured to:
identify, assess, and facilitate the mitigation of use-related risks associated with the medical device or combination product;
decision-making and prioritization of risk mitigation strategies based on the analysis of use-related risks;
integrate with project data sources to provide real-time risk analysis and updates, enabling proactive risk management throughout the product development lifecycle.

36. The system of claim 1, wherein the AI-SHF Core module further comprises data processing means for predictive modeling, anomaly detection, and decision tree analysis, each configurable to match specific requirements of varying medical device projects.

37. The system of claim 1, wherein the regulatory compliance assistance is facilitated through an update mechanism within the AI-SHF Core, configured to automatically adapt and integrate changes in global regulatory guidelines and regional specifications.

38. The system of claim 1, wherein the plurality of user interfaces includes personalization features, enabling configuration of the interface layout and functionalities according to the distinct roles of stakeholders, phases of the project lifecycle, or individual user preferences.

39. The system of claim 1, further comprising a collaboration module designed to dynamically organize stakeholder groups based on project-specific needs, requirements, and critical development milestones, thereby enabling efficient and targeted collaborative efforts.

40. The system of claim 1, wherein the data security mechanism incorporates advanced protocols including real-time threat detection, application of blockchain technology for ensuring data integrity, and utilization of multi-factor authentication for access control.

41. The method of claim 20, further includes adaptive capability building features, providing personalized training modules, and development pathways tailored to enhance specific maturity areas within the framework through gamified learning experiences and interactive simulations to reinforce best practices and foster continuous improvement.

42. The method of claim 20, further comprising:
monitoring the performance of human factors project strategies, identifying areas for improvement, and measuring their impact on product success and user satisfaction, and predicting product success;
adapting to accommodate a wide range of medical device projects and evolving industry standards and regulations;
analyzing data collected during human factors projects to identify patterns, detect anomalies, and extract insights;
conducting virtual simulations to replicate real-world scenarios, identify usability issues, evaluate design alternatives, and validate the effectiveness of human factors interventions;
utilizing Internet of Things (IoT) connectivity for real-time data collection from interconnected systems and medical devices, contributing to a centralized database of user behavior data and use-context information; and
utilizing AI algorithms for the analysis of HF and usability project-specific data in conjunction with applicable regulatory standards and best practices.

43. The method of claim 20, further comprising the steps of collecting feedback in real-time from user interactions with the medical device, analyzing said feedback using the AI-SHF Core, and iteratively refining the design of the device or human factors strategies based on insights derived from said analysis.

44. The method of claim 20, wherein conducting multimodal risk assessments involves aggregating data sourced from IoT devices among other data sources, to proactively identify, evaluate, and mitigate use-related risks associated with the medical device.

45. The method of claim 20, further characterized by adaptive training modules that adjust educational content and difficulty level based on the progress, feedback, and identified learning needs of various stakeholders, factoring in evolving industry standards and regulations.

46. The method of claim 20, comprising predicting maintenance requirements and usability improvements by applying AI-based predictive analytics to assess potential failure points or usability challenges before they manifest, thereby informing preventive measures and design optimizations.

47. The method of claim 20, including a protocol for ensuring seamless integration and interoperability with various medical device development tools and platforms, said protocol specifying data exchange standards, compatibility checks, and protocol adherence to facilitate effective data synchronization and functionality harmony.

48. The method of claim 20, further comprising embedding and integrating human factors considerations throughout the product development lifecycle and within stakeholders' Quality Management Systems (QMS), ensuring that usability, safety, and regulatory compliance aspects are intrinsically unified and interwoven into user-centered design and development processes from the initial concept.

49. The method of claim 20, further comprising the mechanisms for embedding human factors considerations are designed to facilitate a cohesive approach to product development by integrating human factors considerations at each stage, ensuring that safety, usability, and regulatory compliance are integral parts of the design and development processes.

50. The method of claim 20, further comprising determining human factors regulatory submission categories based on an automated analysis of the applicable regulatory guidelines and risk levels, to ensure an appropriate and compliant submission for regulatory review.

51. The method of claim 20, further comprising proactively encouraging innovation and regulatory compliance in human factors engineering (HFE) projects by providing stakeholders with fit-for purpose AI solutions, models, state-of-the-art tools, methodologies, and resources previously unavailable.
